(19) United States
(12) Patent Application Publication
(10) Pub. No.: US 2018/0076924 A1
(43) Pub. Date: Mar. 15, 2018

(54) METHOD AND DEVICE OF MULTI-SUBBAND BASED TRANSMISSION FOR A WIRELESS TRANSMIT/RECEIVE UNIT (WTRU) WITH REDUCED CAPABILITY AND COVERAGE ENHANCEMENT

(71) Applicant: InterDigital Patent Holdings, Inc., Wilmington, DE (US)

(72) Inventors: Moon-il LEE, Melville, NY (US); Janet A. STERN-BERKOWITZ, Little Neck, NY (US)

(73) Assignee: InterDigital Patent Holdings, Inc., Wilmington, DE (US)

(21) Appl. No.: 15/564,630

(22) PCT Filed: Apr. 8, 2016
(86) PCT No.: PCT/US2016/026668

§ 371 Date: Oct. 5, 2017

Related U.S. Application Data
(60) Provisional application No. 62/144,830, filed on Apr. 8, 2015.
(60) Provisional application No. 62/161,045, filed on May 13, 2015.

(51) Int. Cl. H04L 1/00; H04L 5/00; H04W 72/04

(52) U.S. Cl. CPC H04L 1/0026; H04W 72/0446; H04W 72/042; H04L 5/0094

(57) ABSTRACT

Method, devices and systems of multi-subband based transmission are disclosed herein. A method for use in a wireless transmit/receive unit (WTRU) includes monitoring a plurality of subbands for subbands that include an enhanced physical downlink control channel (EPDCCH), wherein each subband of the plurality of subbands is made up of a subset of frequency resources in a system bandwidth, and determining whether each of the plurality of subbands is a channel state information (CSI) downlink subband (CSI-subband) for CSI feedback based on whether an EPDCCH is included in a corresponding subband of the plurality of subbands. At least two subbands of the plurality of subbands, in which a corresponding EPDCCH is included, are determined as CSI subbands for CSI feedback.

### CROSS REFERENCE TO RELATED APPLICATIONS

This application claims the benefit of U.S. provisional application No. 62/144,830, filed Apr. 8, 2015, and U.S. provisional application No. 62/161,045, filed May 13, 2015, the contents of which are hereby incorporated by reference herein.

### BACKGROUND

A coverage enhanced wireless transmit/receive unit (WTRU) may be a WTRU which may require coverage enhancement or a WTRU which may employ coverage enhancement (CE) techniques or may support a CE mode. A mode of operation without CE may be referred to as a normal mode operation.

A repetition of a downlink or an uplink channel may be used for the CE. One or more CE levels may be used and a CE level may correspond to a certain number of repetitions. A lower CE level may use a smaller number of repetitions and a higher CE level may use a larger number of repetitions.

A reduced bandwidth (BW) WTRU may be a WTRU which may (or may only) support a certain limited BW (e.g., radio frequency (RF) BW) or a certain limited number of resource blocks (RBs) in the downlink (DL) and/or uplink (UL) which may be independent of the BW of the eNode-B or cell with which the WTRU may communicate. For example, a limited BW WTRU may (or may only) support a certain number of RBs (e.g., 6 RBs) or a certain amount of BW (e.g., 1.4 megahertz (MHz)) for transmission and/or reception. Such a WTRU may communicate with an eNode-B or cell for which the BW may be larger (e.g., 20 MHz or 100 RBs). This WTRU may use or require special procedures to operate in a portion of the full BW of the cell. A WTRU which may support the full BW of a cell may be referred to as a full BW WTRU. A BW may include a number of RBs and/or a location in a band such as the center of the band.

### SUMMARY

Method, devices and systems of multi-subband based transmission are disclosed herein.

For example, a method for use in a WTRU includes: monitoring a plurality of subbands for subbands that include an enhanced physical downlink control channel (EPDCCH), wherein each subband of the plurality of subbands is made up of a subset of frequency resources in a system bandwidth, and determining whether each of the plurality of subbands is a channel state information (CSI) downlink subband (CSI-subband) for CSI feedback based on whether an EPDCCH is included in a corresponding subband of the plurality of subbands. At least two subbands of the plurality of subbands, in which a corresponding EPDCCH is included, are determined as CSI subbands for CSI feedback.

In another example, a WTRU includes: a receiver and at least one processor configured to monitor a plurality of subbands for subbands that include an enhanced physical downlink control channel (EPDCCH), wherein each subband of the plurality of subbands is made up of a subset of frequency resources in a system bandwidth. The the at least one processor is configured to determine whether each of the plurality of subbands is a channel state information (CSI) downlink subband (CSI-subband) for CSI feedback based on whether an EPDCCH is included in a corresponding subband of the plurality of subbands. At least two subbands of the plurality of subbands are determined as CSI subbands for CSI feedback based on a corresponding EPDCCH included therein.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example radio access network and an example core network that may be used within the communications system illustrated in FIG. 1A;

FIG. 2 is a diagram of an example of a contention based random access (RA) procedure;

FIG. 3 is a diagram of an example of a multiple downlink (DL) subbands (D-subbands) configuration in a system supporting a reduced bandwidth (BW) WTRU;

FIG. 4 is a diagram of an example of a multiple U-subband configuration in a system supporting a reduced BW WTRUs;

FIG. 5 is a diagram of an example of D-subband mapping based on the physical random access channel (PRACH) resource used;

FIG. 6 is a diagram of an example of D-subband mapping based on the WTRU-ID;

FIG. 7 is a diagram of an example of multiple D-subbands mapping based on the PRACH resource used;

FIG. 8 is a diagram of an example of narrow band enhanced physical downlink control channels (NB-EPDCCH) user equipment (UE) specific search space (USS)/common search space (CSS) configuration with multiple D-subbands;

FIG. 9 is a diagram of an example of logical DL subband (LD-subband) and physical DL subband (PD-subband) mapping for primary and secondary DL control subbands (DC-subbands);

FIG. 10 is a diagram of an example in-subframe association with multiple subbands;

FIG. 11 is a diagram of an example of cross-subframe scheduling indication from downlink control information (DCI);

FIG. 12 is a diagram of an example of an offset k according to the D-subband frequency location of the second subframe;

FIG. 13 is a diagram of an example of an offset k according to the D-subband frequency location of the second subframe for multiple WTRUs;

FIG. 14 is a diagram of an example of a WTRU reception behavior with cross-subframe association;

FIG. 15 is a diagram of an example of a D-subband configuration for NB-EPDCCH USS and CSS;

FIG. 16 is a diagram of an example of D-subband and uplink (UL) subband (U-subband) linkage;

FIG. 17 is a diagram of an example of a common uplink control subband (UC-subband) with a WTRU-specific uplink data subbands (UD-subbands) configuration;

FIG. 18 is a diagram of an example of a multiple UC-subbands configuration for a certain uplink channel and association with multiple DC subbands;

FIG. 19 is a diagram of an example of a configuration of channel state information (CSI) subbands and uplink subband linkage; and

FIG. 20 is a diagram of an example mapping to physical resource blocks for a physical uplink control channel (PUCCH).

### DETAILED DESCRIPTION

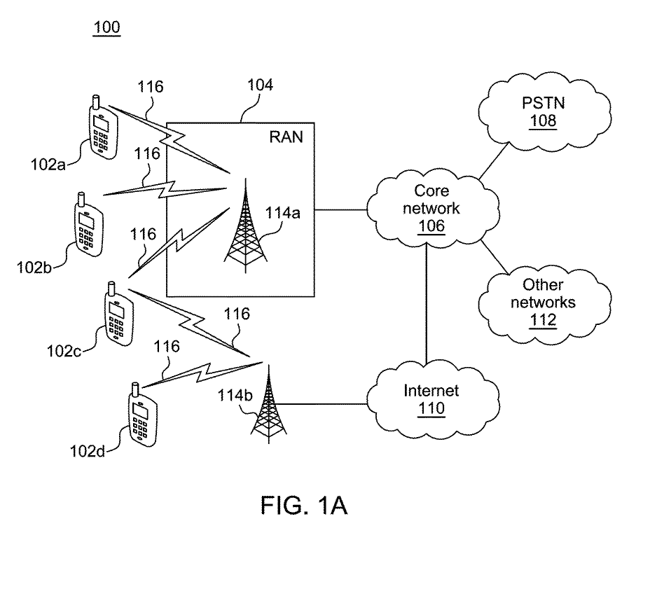

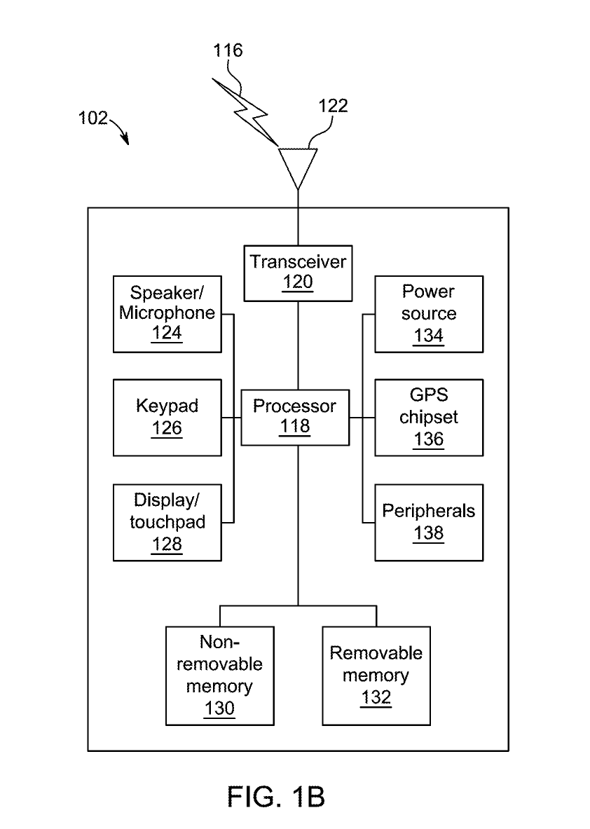

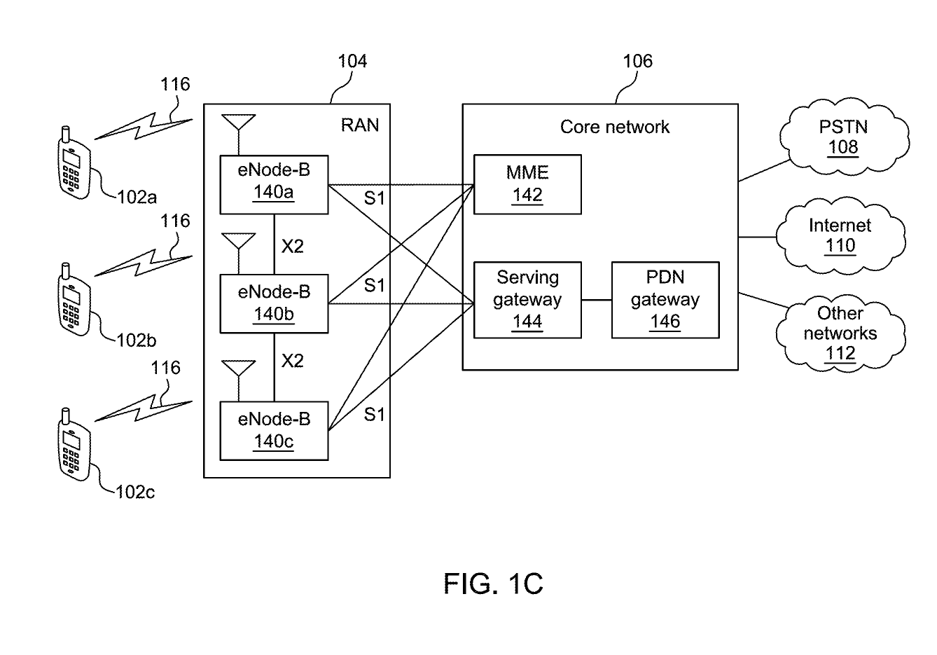

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like. As used herein, a WTRU may also be referred to as a wireless communication device.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the other networks 112. By way of example, the base stations 114a, 114b may be a base transceiver station (BTS), a Node-B, an eNode B, a Home Node B, a Home eNode B, a site controller, an access point (AP), a wireless router, and the like. As used herein, a base station may also be referred to as a wireless communication device. As used herein, an AP may also be referred to as a wireless communication device. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple-output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. As noted above, the RAN 104 may employ an E-UTRA radio technology to communicate with the WTRUs 102a, 102b, 102c over the air interface 116. The RAN 104 may also be in communication with the core network 106.

The RAN 104 may include eNode-Bs 140a, 140b, 140c, though it will be appreciated that the RAN 104 may include any number of eNode-Bs while remaining consistent with an embodiment. The eNode-Bs 140a, 140b, 140c may each include one or more transceivers for communicating with the WTRUs 102a, 102b, 102c over the air interface 116. In one embodiment, the eNode-Bs 140a, 140b, 140c may implement MIMO technology. Thus, the eNode-B 140a, for example, may use multiple antennas to transmit wireless signals to, and receive wireless signals from, the WTRU 102a.

Each of the eNode-Bs 140a, 140b, 140c may be associated with a particular cell (not shown) and may be configured to handle radio resource management decisions, handover decisions, scheduling of users in the uplink and/or downlink, and the like. As shown in FIG. 1C, the eNode-Bs 140a, 140b, 140c may communicate with one another over an X2 interface.

The core network 106 shown in FIG. 1C may include a mobility management entity gateway (MME) 142, a serving gateway 144, and a packet data network (PDN) gateway 146. While each of the foregoing elements are depicted as part of the core network 106, it will be appreciated that any one of these elements may be owned and/or operated by an entity other than the core network operator.

The MME 142 may be connected to each of the eNode-Bs 140a, 140b, 140c in the RAN 104 via an S1 interface and may serve as a control node. For example, the MME 142 may be responsible for authenticating users of the WTRUs 102a, 102b, 102c, bearer activation/deactivation, selecting a particular serving gateway during an initial attach of the WTRUs 102a, 102b, 102c, and the like. The MME 142 may also provide a control plane function for switching between the RAN 104 and other RANs (not shown) that employ other radio technologies, such as GSM or WCDMA.

The serving gateway 144 may be connected to each of the eNode Bs 140a, 140b, 140c in the RAN 104 via the S1 interface. The serving gateway 144 may generally route and forward user data packets to/from the WTRUs 102a, 102b, 102c. The serving gateway 144 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 144 may also be connected to the PDN gateway 146, which may provide the WTRUs 102a, 102b, 102c with access to packet-switched networks, such as the Internet 110, to facilitate communications between the WTRUs 102a, 102b, 102c and IP-enabled devices.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

As used herein, the terms coverage limited WTRU, coverage enhanced WTRU, a WTRU with enhanced coverage, a WTRU operating an enhanced coverage mode, a WTRU using an enhanced coverage mode, a WTRU using a coverage enhancement (CE) mode, and a WTRU in a coverage enhanced mode of operation may be used interchangeably. The terms normal mode operation and non-coverage enhanced mode of operation may be used interchangeably. As used herein, the terms reduced bandwidth (BW), limited BW, and BW limited may be used interchangeably. Also, as used herein, a WTRU, a BW limited WTRU, a WTRU with limited capability, low-cost WTRU, low-cost machine type communication (LC-MTC), a WTRU with limited BW capability, and a reduced BW WTRU may be used interchangeably. Also, a legacy WTRU, a legacy LTE WTRU, and a WTRU without limited capability may be used interchangeably herein.

As used herein, the terms eNode-B and cell may be used interchangeably. Also, the terms component carrier (CC) and serving cell may be used interchangeably. Further, the terms WTRU, WTRU medium access control (MAC) entity, and MAC entity may be used interchangeably. In addition, the terms random access channel (RACH) resources and physical random access channel (PRACH) resources may be used interchangeably.

As used herein, the terms DL subband, D-subband, d-subband, and DL-subband may be used interchangeably. Also, the terms UL subband, U-subband, and UL-subband may be used interchangeably.

The WTRU may receive a configuration including resource information for a plurality of subbands, wherein a subband may be a downlink (DL) subband (D-subband), an uplink (UL) subband (U-subband) or both. The WTRU may determine the number of D-subbands and/or U-subbands and/or their frequency location in a subframe based on one or more system parameters, including a physical cell-identifier (ID), multicast-broadcast single-frequency network (MBSFN) configuration, and system BW for UL. The WTRU may be a coverage enhanced WTRU and/or a reduced bandwidth (BW) WTRU. The WTRU may also receive, on one or more D-subbands, one or more narrow band enhanced physical downlink control channels (NB-EPDCCHs). The NB-EPDCCH may be an NB-EPDCCH user equipment (UE) specific search space (USS), an NB-EPDCCH common search space (CSS), or both. Further, it will be understood that the terms EPDCCH and a machine-type communication physical downlink control channel (MPDCCH) may be used interchangeably.

A WTRU may use multiple subbands for channel state information (CSI) feedback. Aperiodic and periodic CSI reporting modes of operation may be used. The associated D-subband and/or U-subband may be determined. CSI measurement and reporting may involve collision handling with other signals and include prioritization of the signal.

A WTRU may transmit a sounding reference signal (SRS) with multiple subbands. A cell-specific and WTRU-specific SRS subband and/or subframe may be configured. A U-subband may be determined for SRS transmission. Also, collision handling between SRS and other uplink signals may include prioritization of the signal.

Multiple subband configurations, including for UL and DL for a reduced BW WTRU, are disclosed herein. Also, multiple subband configurations with a determination of a DL or a UL subband in a subframe based on a system and/or a WTRU parameters are disclosed herein.

A DL control channel with multiple subbands is also disclosed herein. An example includes a DL subband determination within the plurality of downlink subbands for narrow band enhanced physical downlink control channel (NB-EPDCCH) monitoring. User equipment-specific search space (USS) and common search space (CSS) with multiple downlink subbands are also disclosed herein. Further, a WTRU monitoring behavior for NB-EPDCCH USS and CSS in a same subframe with multiple downlink subbands is disclosed herein.

An association between control and data channels with multiple subbands is also disclosed herein. An example includes a use of a guard subframe when frequency hopping is used across multiple subbands configured. Also, mapping between multiple downlink subbands and uplink subbands based on a configuration (e.g., system parameters and/or WTRU-specific parameters) is disclosed herein. Further, an acknowledgment (ACK)/negative acknowledgement (NACK) resource allocation with cross-subframe association is disclosed herein. In addition, in an example a subframe association type may be determined as a function of NB-EPDCCH search space.

A WTRU may use multiple subbands for channel state information (CSI) feedback. Aperiodic and periodic CSI reporting modes of operation may be used. The associated D-subband and/or U-subband may be determined. CSI measurement and reporting may involve collision handling with other signals and include prioritization of the signal.

A WTRU may transmit a sounding reference signal (SRS) with multiple subbands. A cell-specific and WTRU-specific SRS subband and/or subframe may be configured. A U-subband may be determined for SRS transmission. Also, collision handling between SRS and other uplink signals may include prioritization of the signal.

A WTRU may at least sometimes communicate, behave or operate in a manner which may be consistent (e.g., at least partially consistent) with that of a full BW WTRU and may at least sometimes (e.g., some other times) communicate, behave or operate in a manner which may be consistent (e.g., at least partially consistent) with that of a reduced BW WTRU. For example, a WTRU which may support the full BW of a cell may communicate, behave, or operate in a manner which may be consistent (e.g., at least partially consistent) with that of a reduced BW WTRU at certain times, such as when it may be coverage limited or when it may operate in coverage enhancement (CE) mode. A WTRU, such as this WTRU, may be or may be considered a full BW WTRU and/or a reduced BW WTRU, for example, at least sometimes.

A WTRU may be or may be considered to be a reduced BW WTRU while it may (or may need to or intend to) behave or operate like (e.g., at least partially like) a reduced BW WTRU. A WTRU which may communicate (e.g., with an eNode-B), behave, or operate in a manner which may be consistent (e.g., at least partially consistent) with that of a reduced BW WTRU may be or may be considered to be a reduced BW WTRU, for example at least sometimes such as when the WTRU may communicate, behave, or operate in a manner which may be consistent (e.g., at least partially consistent) with that of a reduced BW WTRU.

Embodiments disclosed herein for reduced BW WTRUs may be applied to coverage limited WTRUs and vice-versa. Coverage limited and reduced BW WTRUs are examples of WTRUs for which the embodiments described herein may apply. These are non-limiting examples. Application to a WTRU of any kind, with any capabilities, or reduced capabilities would still be consistent with this disclosure.

In examples disclosed herein, a physical downlink control channel (PDCCH) may be replaced by an enhanced physical downlink control channel (EPDCCH) and vice-versa and still be consistent with this disclosure. Also, in examples disclosed herein, a WTRU or a certain WTRU or WTRUs may be replaced by at least a WTRU or at least a certain WTRU or WTRUs and still be consistent with this disclosure. Further, in examples disclosed herein, intended for may be replaced by at least intended for or intended for at least and still be consistent with this disclosure.

In an example, a RACH procedure and a PRACH may be used. In LTE, the Random Access (RA) procedure may be used in certain situations such as one or more of the following. First, the Random Access procedure may be used for a radio resource control (RRC) Connection Request, such as for initial access or to register. Second, the Random Access procedure may be used for an RRC Connection re-establishment, such as following radio link failure. Third, the Random Access procedure may be used during a handover to access a target cell. Fourth, the Random Access procedure may be used to obtain UL synchronization such as when UL synchronization is lost and DL data arrives or there is UL data to send. Fifth, the Random Access procedure may be used when the WTRU has UL data to send and there are no dedicated resources (e.g., no physical uplink control channel (PUCCH) resources have been assigned to the WTRU which may enable it to send a scheduling request (SR)). Sixth, the Random Access procedure may be used for positioning purposes, such as when timing advance is needed for WTRU positioning.

There may be two forms of the RA procedure: contention-based (which may also be called common), which may apply to the first five events above; and non-contention based (which may also be called contention free or dedicated), which may apply or only apply to handover, DL data arrival, and positioning. When using a contention-based RA procedure, the WTRU may initiate the process by transmitting a RA preamble it randomly chooses from a common pool of preambles which may be communicated to the WTRU by the network, such as via broadcasted system information (SI). The WTRU may transmit the preamble on a PRACH resource (e.g., a resource in time and frequency) that the WTRU chooses from a set of allowed resources which may be communicated to the WTRU by the network such as via broadcasted system information. This set of allowed PRACH resources may be referred to as the cell's configured set of PRACH resources. The unit of time for the PRACH resource may be a subframe. The subframe the WTRU chooses for the PRACH resource may be the next subframe configured for PRACH in which the WTRU can transmit the PRACH (e.g., based on timing, measurement, and other WTRU constraints). The frequency aspect of the PRACH resource (e.g., the resource blocks (RBs)) the WTRU chooses in the selected subframe may be based on parameters communicated to the WTRU by the network such as via broadcasted system information. In certain cases, for example, for frequency division duplex (FDD), there may be one frequency resource allowed for PRACH in any subframe. It may be defined by a starting (lowest) RB number which may be provided by the network, e.g., prach-FrequencyOffset, and may have a fixed BW such as 6 RBs.

When a contention-based random access procedure is used, it is possible that at least two WTRUs select the same resources (e.g., same preamble and PRACH resource) for random access, and, thus, the contention situation may need to be resolved. When using a non-contention based RA procedure, the WTRU may transmit a RA preamble explicitly signaled to the WTRU by the network, e.g., ra-PreambleIndex. The WTRU may transmit the preamble on a PRACH resource it chooses from a specific subset of the cell's configured PRACH resources where the subset (e.g., the mask) may be explicitly signaled to the WTRU by the network, e.g., ra-PRACH-MaskIndex. In the case where the subset includes only one choice, the WTRU may use the indicated resource.

In some examples which may be applicable to one or both of the RA procedure types, the preamble transmission may span or be repeated over more than one subframe. In this case, the selected subframe may be the starting subframe for the transmission.

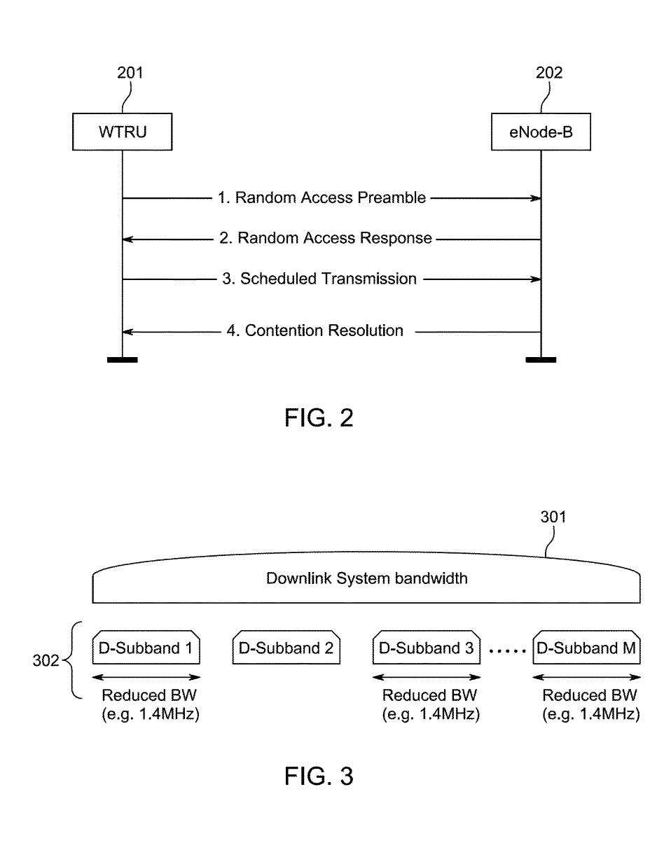

FIG. 2 is a diagram of an example of a contention based RA procedure. The contention based RA procedure may include several transmissions, which may be transmitted as follows. In transmission 1, a WTRU 201 may transmit the selected RA preamble on the selected PRACH resource to a network (e.g., eNode-B 202). After transmitting the preamble, the WTRU 201 may read the PDCCH and look for the Random Access Radio Network Temporary ID (RA-RNTI) corresponding to the first subframe on which it transmitted the preamble. If it is not received in the response monitoring window, the WTRU may ramp up the power, select another resource, possibly after some backoff time, and try again. The RA-RNTI may be determined according to:

RA-RNTI=1+t_id+10*f_id Equation (1)

In an example, t_id may be the index of the first subframe of the PRACH used for preamble transmission (e.g., 0≦t_id<10), and f_id may be the index of the PRACH used for preamble transmission within that subframe, in ascending order of frequency domain (e.g., 0≦f_id<6). For the case of one frequency resource per subframe, e.g., for FDD, f_id may always be 0.

Transmission 2 may include a Random Access Response (RAR). In an example, transmitting transmission 2 may consist of a network (e.g., eNode-B 202) transmitting a timing advance command to adjust the terminal transmit timing. The network may also allocate uplink resources for the WTRU 201 and may send a response on the downlink control channel (PDCCH) using the RA-RNTI to identify which WTRU group the allocation (e.g., scheduling grant) is for. Within each group, the RA preamble identifier (RAPID) may be used to narrow down further (e.g., at the MAC level) the WTRU group specified by the RA-RNTI to the subset of WTRUs which have used the same preamble during transmission 1 of the random access procedure. The RA response may include one or more of the index of the random access preamble sequences the network detected and for which the response is valid, the timing correction calculated by the random access preamble receiver, a scheduling grant, and a temporary cell identity (TC-RNTI).

Transmission 3 may include a scheduled transmission. In an example, the WTRU 201 may use the allocated resources indicated by the scheduling grant to transmit its message (such as RRC Connection Request) to the network (e.g., eNode-B 202). If the terminal is connected to a known cell (e.g., in RRC_CONNECTED state), the terminal may have a Cell RNTI (C-RNTI) which it may include in the uplink message. Otherwise a core network terminal identifier may be used. The uplink synchronization channel (UL SCH) may be scrambled by the WTRU 201 using the TC-RNTI received in transmission 2. Transmission 3 may be referred to as Message 3 (Msg3).

Transmission 4 may include a contention resolution. In an example, the network (e.g., eNode-B 202) may send a contention resolution message on the downlink based either on a C-RNTI on a PDCCH or a WTRU contention resolution identity on the DL-SCH, e.g., the core network terminal identifier sent by the terminal in transmission 3. Only the terminal which observes a match between the identity received in this transmission and the identity transmitted as part of transmission 3 will declare the RA procedure successful. Contention between WTRUs that chose both the same PRACH time-frequency resource and the same preamble may be resolved by this transmission.

For contention based RA, the WTRU 201 may derive the common pool of preambles from parameters provided by the network (e.g., eNode-B 202). From these parameters, the WTRU 201 may derive a full set of preambles, e.g., a certain number, such as 64 preambles, which may be based on one or more root Zadoff-Chu sequences. A parameter which may designate the sequence or sequences to use may be rootSequenceIndex. The WTRU 201 may receive additional parameters indicating a subset of the preambles which may be used by the WTRU and how to divide this subset into groups such as two groups, A and B. For example, numberOfRA-Preambles may define the subset of preambles. The first sizeOfRA-PreamblesGroupA may be in group A (e.g., preambles 0 to sizeOfRA-PreamblesGroupA—1), and the remaining preambles in the subset, if any (e.g., sizeOfRA-PreamblesGroupA to numberOfRA-Preambles—1), may be in Group B. When to use a Group A versus a Group B preamble may be known to the WTRU 201. The decision may be based on criteria such as the size of Msg3 or pathloss, or both. Preambles in the full set which are not in Group A or B may be used by the network when it assigns dedicated preambles.

A PRACH Configuration Index, e.g., prach-ConfigIndex, may be used by the network to tell the WTRU which of a preset list of possible configurations it is choosing for the cell's configured set of PRACH resources. The preset configurations may define, for example for FDD, one or more of the preamble format, which may define the time for the preamble cyclic prefix (CP) and the time for the preamble sequence, the system frame numbers (SFNs) in which PRACH is allowed (e.g., any, even only, odd only), and the subframes of the allowed SFNs (e.g., a specific 1, 2, 3, 4, 5, or all 10 subframes) in which PRACH is allowed.

A PUCCH resource allocation may be made. The physical resources used for PUCCH may depend on two parameters, N_{RB}⁽²⁾ and N_{CS}⁽¹⁾, given by higher layers. The variable N_{RB}⁽²⁾≧0 denotes the bandwidth in terms of resource blocks that are available for use by PUCCH formats 2/2a/2b transmission in each slot. The variable N_{CS}⁽¹⁾ denotes the number of cyclic shift used for PUCCH formats 1/1a/1b in a resource block used for a mix of PUCCH formats 1/1a/1b and 2/2a/2b. The value of N_{CS}⁽¹⁾ may be an integer multiple of Δ_{shift}^{PUCCH} within the range of {0, 1, . . . , 7}, where Δ_{shift}^{PUCCH} may be provided by higher layers. No mixed resource block may be present if N_{CS}⁽¹⁾=0. At most one resource block in each slot may support a mix of formats 1/1a/1b and 2/2a/2b. Resources used for transmission of PUCCH formats 1/1a/1b, 2/2a/2b and 3 may be represented by the non-negative indices n_{PUCCH}^{(1,\tilde{p})},

$${n}_{PUCCH}^{( 2 , \tilde{p} )} < {N}_{RB}^{( 2 )} {N}_{sc}^{RB} + ⌈ \frac{{N}_{cs}^{( 1 )}}{8} ⌉ \cdot ( {N}_{sc}^{RB} - {N}_{cs}^{( 1 )} - 2 ) ,$$

and n_{PUCCH}^{(3,\tilde{p})}, respectively.

The block of complex-valued symbols z_{(\tilde{p})}(i) may be multiplied with the amplitude scaling factor β_{PUCCH} in order to conform to the transmit power P_{PUCCH} which may be specified, and mapped in sequence starting with z_{(\tilde{p})}(0) to resource elements. PUCCH may use one resource block in each of the two slots in a subframe. Within the physical resource block used for transmission, the mapping of z_{(\tilde{p})}(i) to resource elements (k,l) on antenna port P and not used for transmission of reference signals may be in increasing order of first k, then l and finally the slot number, starting with the first slot in the subframe. The relation between the index \tilde{p} and the antenna port number p may be given.

The physical resource blocks to be used for transmission of PUCCH in slot nₛ may be given by:

$${n}_{PRB} = \begin{matrix}\{ \begin{matrix}⌊ \frac{m}{2} ⌋ & if ( m + {n}_{s} mod 2 ) mod 2 = 0 \\ {N}_{RB}^{UL} - 1 - ⌊ \frac{m}{2} ⌋ & if ( m + {n}_{s} mod 2 ) mod 2 = 1\end{matrix} & Equation ( 2 )\end{matrix}$$

where the variable m may depend on the PUCCH format. For PUCCH formats 1, 1a and 1b, m is provided as follows:

$$\begin{matrix}m = \{ \begin{matrix}{N}_{RB}^{( 2 )} & \begin{matrix}if {n}_{PUCCH}^{( 1 , \tilde{p} )} < \\ c \cdot {N}_{cs}^{( 1 )} / {Δ}_{shift}^{PUCCH}\end{matrix} \\ ⌊ \frac{{n}_{PUCCH}^{( 1 , \tilde{p} )} - c \cdot {N}_{cs}^{( 1 )} / {Δ}_{shift}^{PUCCH}}{c \cdot {N}_{sc}^{RB} / {Δ}_{shift}^{PUCCH}} ⌋ + & otherwise \\ {N}_{RB}^{( 2 )} + ⌈ \frac{{N}_{cs}^{( 1 )}}{8} ⌉ & \end{matrix} & Equation ( 3 ) \\ c = \{ \begin{matrix}3 normal cyclic prefix \\ 2 exended cyclic prefix\end{matrix} & Equation ( 4 )\end{matrix}$$

For PUCCH formats 2, 2a and 2b, m is provided as follows:

m=└n_{PUCCH}^{(2,\tilde{p})}/N_{sc}^{RB}┘ Equation (5)

For PUCCH format 3, in is provided as follows:

m=└n_{PUCCH}^{(3,\tilde{p})}/N_{SF,0}^{PUCCH}┘ Equation (6)

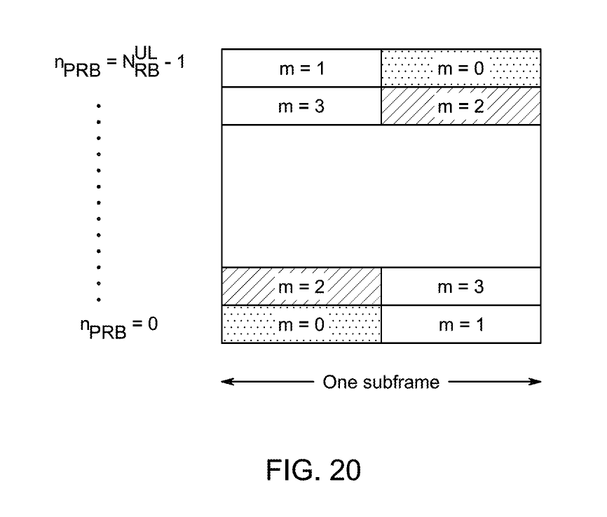

FIG. 20 is a diagram of an example mapping to physical resource blocks for a PUCCH. Mapping of modulation symbols for the physical uplink control channel is illustrated in FIG. 20. In case of simultaneous transmission of sounding reference signal and PUCCH format 1, 1a, 1b or 3 when there is one serving cell configured, a shortened PUCCH format may be used where the last SC-FDMA symbol in the second slot of a subframe shall be left empty.

Hybrid Automatic Repeat reQuest (HARQ)-ACK transmission on two antenna ports (pε[p₀,p₁]) may be supported for PUCCH format 1a/1b. For FDD and one configured serving cell, the WTRU may use PUCCH resource n_{PUCCH}^{(1,\tilde{p})} for transmission of HARQ-ACK in subframe n for \tilde{p} mapped to antenna port p for PUCCH format 1a/1b, where for a physical downlink shared channel (PDSCH) transmission indicated by the detection of a corresponding PDCCH in subframe n−4, or for a PDCCH indicating downlink SPS release (which may be defined) in subframe n−4, the WTRU may use n_{PUCCH}^{(1,\tilde{p}}^{₀}⁾=n_{CCE}+n_{PUCCH}⁽¹⁾ for antenna port p₀, where n_{CCE} is the number of the first CCE (i.e., a lowest CCE index used to construct the PDCCH) used for transmission of the corresponding downlink control information (DCI) assignment and N_{PUCCH}⁽¹⁾ is configured by higher layers. For two antenna port transmission the PUCCH resource for antenna port p₁ may be given by n_{PUCCH}^{(1,\tilde{p}}^{₁}⁾=n_{CCE}+1+n_{PUCCH}⁽¹⁾.

Also, for FDD and one configured serving cell, the WTRU may use PUCCH resource n_{PUCCH}^{(1,\tilde{p})} for transmission of HARQ-ACK in subframe n for \tilde{p} mapped to antenna port p for PUCCH format 1a/1b, where for a PDSCH transmission on the primary cell where there is not a corresponding PDCCH detected in subframe n−4, the value of n_{PUCCH}^{(1,\tilde{p})} may be determined according to higher layer configuration and/or other information. For a WTRU configured for two antenna port transmission, a PUCCH resource value may map to two PUCCH resources with the first PUCCH resource n_{PUCCH}^{(1,\tilde{p}}^{₀}⁾ for antenna port P₀ and the second PUCCH resource n_{PUCCH}^{(1,\tilde{p}}^{₁}⁾ for antenna port p₁. Otherwise, the PUCCH resource value may map to a single PUCCH resource n_{PUCCH}^{(1,\tilde{p}}^{₀}⁾ for antenna port p₀.

A WTRU may use an SRS. A WTRU may transmit an SRS to the eNode-B when configured or triggered to do so. The WTRU may transmit SRS in the last symbol of a subframe.

An SRS transmission by a WTRU may be periodic or aperiodic.

Periodic SRS transmission may be configured by the eNode-B. Aperiodic SRS transmissions may be triggered by the eNode-B, e.g., by including a request for aperiodic SRS along with an UL grant.

Cell-specific SRS subframes may be subframes in which an SRS may be transmitted in a given cell. The configuration of cell-specific subframes may be provided in signaling such as broadcast or dedicated RRC signaling.

WTRU-specific SRS subframes may be subframes in which SRS may be transmitted by a certain WTRU which may be a subset of the cell-specific SRS subframes. The configuration of WTRU-specific subframes may be provided to a WTRU in signaling such as dedicated RRC signaling. There may be separate WTRU-specific subframes configured for a WTRU for periodic and aperiodic SRS.

When aperiodic SRS is triggered in subframe n, the WTRU may transmit an SRS in the next aperiodic WTRU-specific SRS subframe n+k where k satisfies a certain criteria, for example k>=4. When one SRS (periodic or aperiodic SRS) and another SRS or channel are both scheduled to be transmitted in the same subframe, rules and/or configuration parameters may govern whether or not the WTRU may transmit the scheduled SRS. As used herein, the terms aperiodic SRS trigger and aperiodic SRS request may be used interchangeably.

The use of one reduced BW for all WTRUs with limited capability in a system may result in capacity limitation for the support of reduced BW WTRUs. The capacity limitation may become more serious if the number of reduced BW WTRUs gets larger in the system.

A multi-subband based transmission may be used to compensate the capacity limitation for both UL and DL transmissions, where a BW limited WTRU may use, intend to use or be configured with one of the multiple subbands configured in a WTRU-specific manner. An uplink transmission or a downlink reception in a subband in a certain subframe may be a repetitive transmission or reception if a WTRU is in coverage enhancement (CE) mode of operation or an individual transmission or reception without repetition if a WTRU is in normal coverage mode of operation.

Multiple subband configurations are disclosed herein. A subband may be defined as a subset of frequency resources in a system BW. One or more of following may apply. A contiguous R physical resource block (PRB)-pairs within a system BW may be used as a subband, where R may be 6 as an example. In a further example, a subband size (e.g., R PRB-pairs) may be defined as the same regardless of the system BW. In another example, a subband size may be determined as a function of the system BW. Also, in an example, a subband size may be distinguished from a broadcasting channel and the maximum subband size may be limited to R PRB-pairs. In yet a further example, a subband size may be different according to a DL or a UL channel.

As disclosed herein, a subband may be used as a reduced BW and may be configured or used for a reduced BW WTRU. A subband may be D-subband, U-subband, or both.

Non-modified LTE configurations may not support multiple subbands. In an example, two or more DL and/or UL subbands may be configured for a reduced BW WTRU and the number of DL and/or UL subbands and their frequency location may be determined as a function of one or more system parameters, wherein the system parameters may include a physical cell-identifier (PCI), multicast-broadcast single-frequency network (MBSFN) configuration, and system BW for UL.

FIG. 3 is a diagram of an example of a multiple D-subbands configuration in a system supporting a reduced BW WTRU. In an example, a downlink system bandwith 301 may include two or more DL subbands 302 (e.g., D-Subband 1, D-Subband 2, D-Subband 3, . . . D-Subband M) that may be preconfigured or used for a reduced BW WTRU. Each DL subband may have a reduced BW of 1.4 MHz, for example. A reduced BW WTRU may receive a DL signal in a certain D-subband in a subframe. FIG. 3 shows an example of the multiple DL subbands configuration (e.g., M D-subbands) for a system supporting a reduced BW WTRU.

In an example, two or more D-subbands 302 may be configured in the system BW and the D-subbands 302 may be non-overlapped in a frequency. Therefore, the D-subbands 302 may be mutually exclusive in the frequency domain.

The configuration of multiple D-subbands 302 may be determined and provided, carried, or signaled in a broadcasting channel by a network (e.g., an eNobe-B) to one or more WTRUs. For example, a certain broadcasting channel used for a reduced BW WTRU and/or coverage enhanced mode of operation (e.g., a low-cost system information block (SIB) (LC-SIB)) may include multiple D-subband configuration information. The multiple D-subband configuration information may include at least one of a number of D-subbands configured or used in a cell (e.g., an eNobe-B), a frequency location of one or more configured D-subbands, a time location of one or more configured D-subbands, and reference signal configuration information for one ore more configured D-subbands.

A number of D-subbands configured or used in a cell may include a maximum number of D-subbands that may be predefined for a certain system BW. For example, the maximum number of D-subbands for a 20 MHz system BW may be 10 D-subbands and the maximum number of D-subbands for a 10 MHz system BW may be 5 D-subbands.

A number of D-subbands configured or used in a cell may include candidate numbers of D-subbands for a certain system BW that may be predefined and one of the candidate numbers may be indicated in the multiple D-subband configuration information. For example, {n1, n2, n3, n4} may be a set of a number of D-subbands candidates and each candidate number may be interpreted differently as a function of the system BW.

A number of D-subbands configured or used in a cell may include a number of D-subbands and/or the frequency locations of the D-subbands that may be determined as a function of one or more of system parameters. The system parameters may include at least one of following: DL system BW, frame structure (e.g., time division duplex (TDD) or FDD), physical cell-ID, MBSFN configuration, DL/UL subframe configuration for TDD, and physical hybrid ARQ indicator channel (PHICH) configuration.

The frequency location of a configured D-subband may indicate a starting PRB-pair number may be used to indicate the frequency location of each D-subband. The starting PRB-pair number may be indicated implicitly or explicitly.

The frequency location of a configured D-subband may indicate an index of each D-subband. In this case, the maximum number of D-subbands and the frequency locations of the D-subbands may be predefined or preconfigured. Each D-subband may be defined as an index, therefore the frequency location of a D-subband may be indicated from the D-subband index. In an example, a set of D-subband index may be indicated. For example, a broadcasting channel may indicate a D-subband index set {1, 3, 5} which may indicate the D-subbands {1, 3, 5} may be configured in the cell for the reduced BW WTRU.

The time location of a configured D-subband may be provided such that each D-subband is configured in all subframes. A D-subband may be configured in a subset of subframes and/or radio frames. For example, the D-subband x may be located in the subframes {0, 4, 5, 9} while the D-subband y may be located in the subframes {1, 2, 3, 6, 7, 8}, where the D-subbands x and y may be one of the D-subbands configured.

In another example, the time location of a configured D-subband may be provided such that the D-subband x may be located in a radio frame which may satisfy a condition A and the D-subband y may be located in a radio frame which may satisfy a condition B. The condition A may be even numbered radio frames and the condition B may be odd numbered radio frames, as an example. The radio frame number may be the same as the SFN.

The time location of a configured D-subband may be provided such that the configured D-subbands may be grouped into two or more sets and the time location of each set may be indicated. For example, if D-subbands {1, 2, 3, 4} are configured and two sets are used such as {1, 2}: set-1 and {3, 4}: set-2, the time location of each set may be indicated. Therefore, the D-subbands in the same set may have the same time location.

The reference signal configuration may be provided such that a reference signal structure for DL signal reception in a D-subband may be indicated. For example, two or more reference signal structures may be used and a reference signal structure may be indicated for each subband. For example, a demodulation reference signal (DM-RS) and cell-specific reference signal (CRS) may be used and each D-subband may be associated with either DM-RS or CRS. The configuration may be the same for all D-subbands or may be independent for each D-subband. Also, the reference signal structure may include a reference signal type (e.g., demodulation purpose, measurement purpose, and the like), a reference signal pattern (e.g., wide band, narrow band, and the like).

In another example, one of the D-subbands may be defined as a primary D-subband which may carry a primary synchronization signal (PSS)/secondary synchronization signal (SSS) and a physical broadcast channel (PBCH). The primary D-subband may be predefined as a center subband, or a subband consisting of the center 6 PRBs of a system bandwidth, and the other secondary D-subbands may be configured via a broadcasting channel. In this case, one or more of following may apply.

The primary D-subband may be used to receive DL signals including at least one of: a synchronization signal (e.g., PSS/SSS), a master information block (MIB) (e.g., PBCH), a common control channel (e.g., PDCCH common search space), and an SIB. The primary D-subband may be considered as common D-subband so that all reduced BW WTRUs may be configured at least in a subset of subframes and/or radio frames. A WTRU in an RRC connected mode may be configured to receive DL signals in a primary D-subband and one or more secondary D-subbands, while a WTRU in an RRC idle mode may receive DL signal in the primary D-subband only.

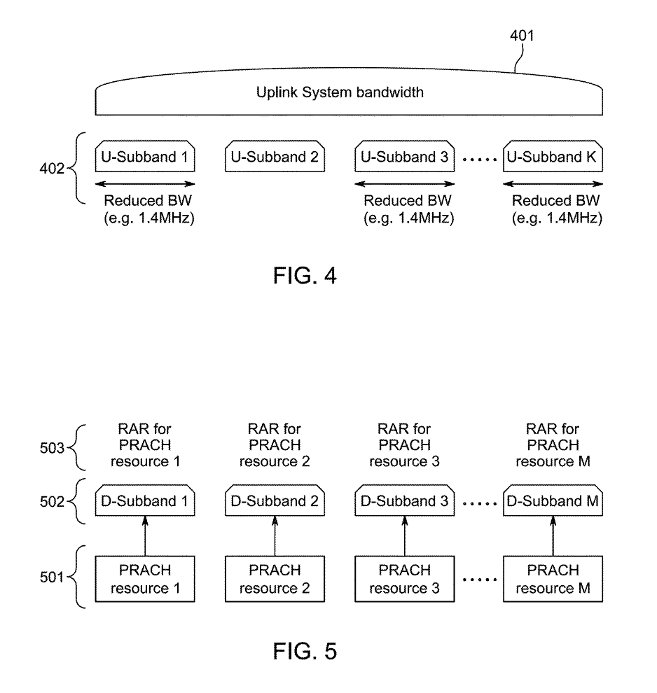

FIG. 4 is a diagram of an example of a multiple U-subband configuration in a system supporting a reduced BW WTRUs. In an example, an uplink system bandwith 401 may include two more UL subbands 402 (e.g., U-Subband 1, U-Subband 2, U-Subband 3, . . . U-Subband K) that may be preconfigured or used for a reduced BW WTRU. Each UL subband may have a reduced BW of 1.4 MHz, for example. A reduced BW WTRU may transmit a UL signal in a certain U-subband in a subframe. FIG. 4 shows an example of a K U-subband configuration for a system supporting a reduced BW WTRU.

In an example, each U-subband may be configured with a contiguous 6 PRB-pairs and two or more U-subbands may be configured in a UL system BW in a non-overlapped manner. The U-subband may be located in non-overlapped frequency location of legacy PUCCH.

The configuration of the U-subbands may be determined and provided by a network (e.g., an eNobe-B) in a broadcasting channel to one or more WTRUs. For example, a broadcasting channel used for a reduced BW WTRU (e.g., LC-SIB) may include U-subband configuration information. The U-subband configuration information may include at least one of a number of U-subbands configured or used in a cell, a frequency location of one or more configured U-subbands, a time location of one or more configured U-subbands, and reference signal configuration information for one ore more configured U-subbands a number of U-subbands configured or used in a cell, a frequency location of one or more configured U-subbands, and a time location of one or more configured U-subbands.

A number of U-subbands configured or used in a cell may be independently configured from the number of D-subbands. The maximum number of U-subbands may be predefined for each system BW. For example, up to 6 U-subbands may be configured if the system BW is 20 MHz, and up to 3 U-subbands may be configurable if the system BW is 10 MHz. The number of U-subband configured may be determined as a function of one or more of system parameters. The system parameters may include at least one of following: a UL system BW, a frame structure (e.g., TDD or FDD), a physical cell-ID, and a DL/UL subframe configuration for TDD. Reserved bits may be used to indicate the number of U-subbands.

The frequency location of each configured U-subband may indicate a starting PRB-pair number may be used to indicate the frequency location of each U-subband.

The frequency location of a configured D-subband may indicate an index of each U-subband. In this case, the maximum number of U-subbands and their frequency locations may be predefined. Each U-subband may be defined as an index, therefore the frequency location of a U-subband may be indicated from the U-subband index. A set of U-subband indexes may be indicated. For example, a broadcasting channel may indicate a U-subband index set {1, 3, 5} which may indicate the U-subbands {1, 3, 5} may be configured in the cell for the reduced BW WTRU.

The time location of a configured U-subband may be provided such that the configured U-subbands may be grouped into two or more sets and the time location of each set may be indicated. A time location of each U-subband may be configured such that a U-subband may be configured in a subset of subframes and/or radio frames. For example, the U-subband x may be located in the subframes containing cell-specific SRS while the U-subband y may be located in the other subframes, where the U-subbands x and y may be one of the U-subbands configured.

In an example, a WTRU may be configured with a WTRU-specific subband configuration. A reduced BW WTRU may transmit or receive in one subband at a time (e.g., in a subframe) even though multiple subbands are configured. In addition, if a same subband is configured for all reduced BW WTRU, there may be a capacity limitation to support the reduced BW WTRUs.

In an example, a WTRU may be configured by the network with two or more DL subbands and the WTRU may receive a DL signal in a certain DL subframe in a subframe, wherein the certain DL subband may be determined as a function of at least one of WTRU-ID, subframe number, SFN number, PRACH resource used for a PRACH preamble transmission, and a coverage enhancement level.

In an example, a reduced BW WTRU may be configured by the network with a D-subband for DL signal reception. A reduced BW WTRU may be configured with a D-subband within the configured D-subbands and the WTRU may receive DL signals in the D-subband. Therefore, a WTRU-specific D-subband may be used.

The WTRU-specific D-subband may be determined as a function of a PRACH preamble transmitted. For example, a D-subband index may be determined based on the PRACH preamble transmitted and the WTRU may receive the corresponding RAR in the D-subband index associated with the PRACH preamble.

The D-subband index may be determined as a function of a PRACH resource used for a PRACH preamble transmission, where two or more of PRACH resources may be predefined or preconfigured.

A PRACH resource associated with a D-subband may be defined or configured as a time/frequency resource. For example, M PRACH resources may be defined or configured in non-overlapped time/frequency resources and each PRACH resource may be associated with a D-subband.

A PRACH partitioning may be used to indicate the associated D-subband. For example, the PRACH resources for BW limited WTRUs may be partitioned into M subsets and each subset may be associated with a D-subband. The partitioning may be used in time, frequency, and/or code (e.g., preamble) domains.

FIG. 5 is a diagram of an example of D-subband mapping based on the PRACH resources used. FIG. 5 shows a number of PRACH resources 501 (e.g., PRACH resource 1, PRACH resource 2, PRACH resource 3, . . . PRACH resource M) mapped to a number of D-subbands 502 (e.g., D-Subband 1, D-Subband 2, D-Subband 3, . . . D-Subband M). A PRACH resource 501 may be associated with one or more D-subbands 502. For example, as shown in FIG. 5, a first PRACH resource 1 may be associated with one D-subband 1 and a second PRACH resource 2 may be associated with a second D-subband 2. If a PRACH resource 501 is associated with one D-subband 502, a WTRU may receive the corresponding RAR 503 in the D-subband 502 associated with the PRACH resource 501. Irrespective of the PRACH resource 501 used for a PRACH preamble transmission, the corresponding RAR 503 may be received in a certain D-subband 502. The certain D-subband where the RAR may be monitored may be defined as a primary D-subband or a common D-subband.

The WTRU-specific D-subband may be configured via higher layer signaling. Therefore, a common D-subband may be used by the WTRU until the WTRU receives the higher layer signaling for the D-subband configuration. The common D-subband may be a predetermined or preconfigured, and/or received in configuration information from the network. For example, the common D-subband may be indicated from a broadcasting channel.

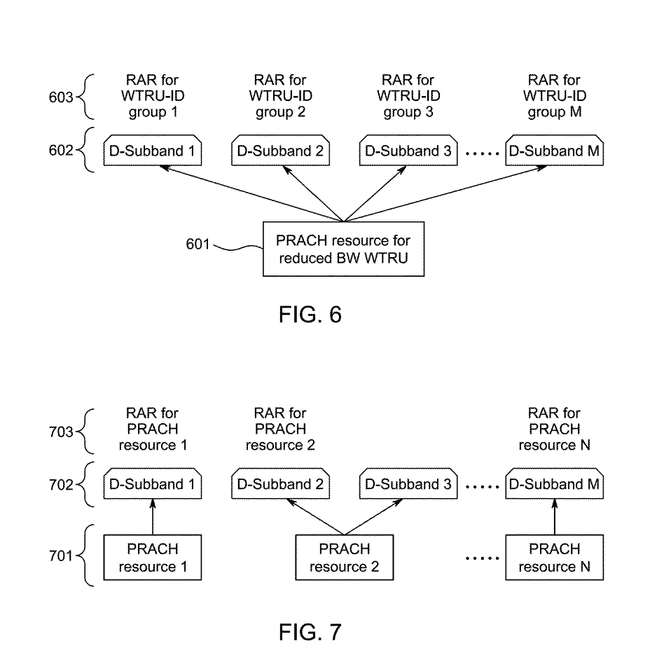

FIG. 6 is a diagram of an example of D-subband mapping based on the WTRU-ID. FIG. 6 shows a PRACH resource 601 mapped to a number of D-subbands 602 (e.g., D-Subband 1, D-Subband 2, D-Subband 3, . . . D-Subband M). In an example, the WTRU-specific D-subband may be determined as a function of a WTRU-ID (e.g., a C-RNTI, an international mobile subscriber identity (IMSI), and the like). For example, a modulo operation may be used to determine the WTRU-specific D-subband. In this case, one or more of following may apply.

A reduced BW WTRU may transmit PRACH preamble in a PRACH resource 601 configured for the reduced BW WTRU and the WTRU may receive the corresponding RAR 603 in a D-subband 602 configured for the WTRU. The RAR 603 may be transmitted without an associated DL control channel. Therefore, a predefined modulation and coding scheme (MCS) level and PRBs may be used.

In another solution, a reduced BW WTRU may be configured with a set of D-subbands for DL signal reception. A reduced BW WTRU may be configured with two or more D-subbands, where the configured D-subbands for the WTRU may be a subset of D-subbands within the D-subbands 602 used for the system, or the same set of D-subbands 602 used for the system may be used for the WTRU.

FIG. 7 is a diagram of an example of multiple D-subbands mapping based on the PRACH resource used. FIG. 7 shows a number of PRACH resources 701 (e.g., PRACH resource 1, PRACH resource 2, . . . PRACH resource N) mapped to a number of D-subbands 702 (e.g., D-Subband 1, D-Subband 2, D-Subband 3, . . . D-Subband M). In an example, two or more D-subbands may be configured as a function of the PRACH resource 701 used for a PRACH preamble transmission. One or more of PRACH resource 701 may be associated with two or more D-subbands 702. In FIG. 7, the PRACH resource 2 may be associated with two D-subbands (e.g., D-Subband 2 and D-Subband 3).

If a PRACH resource 701 is associated with two or more D-subbands 702, a WTRU may receive the corresponding RAR 703 in a preconfigured or a predefined D-subband 702 in the D-subbands associated with the PRACH resource. The preconfigured or predefined D-subband 702 may be the D-subband having a lowest index among the D-subbands associated with the PRACH resource 701. In further example, a primary D-subband may be predefined among the D-subbands associated with a PRACH resource and the corresponding RAR 703 may be transmitted in the primary D-subband.

If a PRACH resource 701 is associated with two or more D-subbands 702, the corresponding RAR 703 may be transmitted in one of the D-subbands. The D-subband 702 where a WTRU may expect to receive the corresponding RAR 703 may be determined as a predetermined D-subband within the associated D-subbands. The predetermined D-subband may be the D-subband having lowest or highest subband index. Also, the corresponding RAR may be determined as a function of WTRU-ID. A modulo operation may be used to determine the D-subband for RAR reception.

In another example, two or more subbands may be configured and a subband used in a certain subframe may be determined as a function of at least one of a subframe number, a radio frame number (e.g., SFN), hybrid automatic repeat request (HARQ) (re)transmission number and a WTRU-ID (e.g., C-RNTI or IMSI). A hashing function may be used to determine the WTRU-specific subbands among the configured subbands for the WTRU.

In an example, a DL signal associated with C-RNTI may be received in the D-subband determined based on the WTRU-ID, subframe number, and/or radio frame number while the other DL signal may be received in a certain predetermined D-subband. The certain predetermined D-subband may be a primary D-subband or a common D-subband.

In a further example, a UL signal associated with C-RNTI may be transmitted in the U-subband determined based on the WTRU-ID, subframe number, HARQ (re)transmission number and/or radio frame number while the other UL signal may be transmitted in a certain U-subband. The U-subband may be predetermined. Also, the U-subband may be broadcast.

A HARQ (re)transmission may be used to determine the subband in which the WTRU may transmit an uplink signal. For example, the first HARQ transmission may be in a first subband determined and a second HARQ retransmission may be in the second subband determined.

In an example, if a reduced BW WTRU is configured with a subband and the frequency location of the configured subband is not changed over time, the performance of the WTRU may be degraded as compared with a legacy WTRU due to the limited frequency diversity gain. In a further example, a WTRU may be configured with a logical (or a first) subband and the frequency location of the logical subband may be determined based on a predefined mapping rule between physical (or a second) subband index and logical subband index, wherein a physical subband index may be associated with a frequency location within the system BW.

In an example, a reduced BW WTRU may be configured with a subband while the frequency location of the subband may be changed over time. For example, a logical subband (L-subband) and a physical subband (P-subband) may be defined and a mapping rule between the logical subband and physical subband may be changed according to the subframe number and/or radio frame number, where the physical subband may be considered as subband in other cases.

As disclosed herein, the logical subband may be a logical DL subband (LD-subband), a logical UL subband (LU-subband), or both. Also, the physical subband may be a physical DL subband (PD-subband), a physical UL subband (PU-subband), or both.

For example, a physical subband (P-subband) may be located in a fixed frequency location while the logical subband (L-subband) frequency location may be determined by a P-subband mapped onto the L-subband in the subframe. Tables 1 and 2 show examples of the L-subband to P-subband mapping rule according to the subframe number and SFN, respectively.

A number of L-subbands may be the same as that of P-subbands. The L-subband to P-subband mapping may be determined as a function at least one of: a subframe number, SFN number, a DL channel type, a mode of operation (e.g., normal coverage mode or coverage enhanced mode) and a HARQ (re)transmission number.

An L-subband may be determined for a WTRU as a function of at least a WTRU-ID, such as, for example, a C-RNTI or an IMSI. A C-RNTI may be used for the DL channel associated with the C-RNTI. Other WTRU-IDs (e.g., an IMSI) may be used for the DL channel associated with the paging RNTI (P-RNTI) or the paging channel.

An L-subband may be determined for a WTRU based on the methods used for a subband determination. An L-subband may be determined based on the NB-EPDCCH candidate number (or a starting NB-EPDCCH enhanced control channel element (ECCE) number) in which an associated DCI may be received by a WTRU.

An L-subband may be received from an associated DCI. A block interleaver or a random interleaver may be used for L-subband to P-subband mapping.

Table 1 shows an example of L-subband to P-subband mapping according to the subframe number. Table 2 shows an example of L-subband to P-subband mapping according to the SFN number.

The L-subband and P-subband mapping rule may be defined as a frequency hopping pattern. In an example, {1, 4, 3, 2} may be used as a frequency hopping pattern for L-subband 1 and {2, 1, 4, 3} may be used as a frequency hopping pattern for L-subband 2 in Table 1. As used herein, the terms frequency hopping pattern, frequency hopping sequence, hopping pattern, subband hopping pattern, and subband hopping sequence may be used interchangeably.

TABLE 1

| | Subframe | Subframe | Subframe | Subframe | Subframe |
|---|---|---|---|---|---|
| | n | n + 1 | n + 2 | n + 3 | n + 4 |
| L-subband | P-subband | P-subband | P-subband | P-subband | P-subband |
| 1 | 1 | 4 | 3 | 2 | 1 |
| L-subband | P-subband | P-subband | P-subband | P-subband | P-subband |
| 2 | 2 | 1 | 4 | 3 | 2 |
| L-subband | P-subband | P-subband | P-subband | P-subband | P-subband |
| 3 | 3 | 2 | 1 | 4 | 3 |
| L-subband | P-subband | P-subband | P-subband | P-subband | P-subband |
| 4 | 4 | 3 | 2 | 1 | 4 |

TABLE 2

| | SFN n | SFN n + 1 | SFN n + 2 | SFN n + 3 | SFN n + 4 |
|---|---|---|---|---|---|
| L-subband | P-subband | P-subband | P-subband | P-subband | P-subband |
| 1 | 1 | 4 | 3 | 2 | 1 |
| L-subband | P-subband | P-subband | P-subband | P-subband | P-subband |
| 2 | 2 | 1 | 4 | 3 | 2 |
| L-subband | P-subband | P-subband | P-subband | P-subband | P-subband |
| 3 | 3 | 2 | 1 | 4 | 3 |
| L-subband | P-subband | P-subband | P-subband | P-subband | P-subband |
| 4 | 4 | 3 | 2 | 1 | 4 |

As used herein, a subband (e.g., D-subband and/or U-subband) may be considered as a L-subband or a P-subband but not limited to. In addition, a D-subband may be considered as a LD-subband or a PD-subband. The U-subband may be considered as LU-subband or a PU-subband.

A DL control channel with multiple subbands may be used in an example. A DL control channel may be monitored and/or received in a certain D-subband preconfigured or predefined and the time/frequency location of the associated PDSCH may be indicated from the DL control channel. The certain D-subband in which a WTRU may monitor or receive a DL control channel may be referred to as a DL control subband (DC-subband). Also, the machine-type communication physical downlink control channel (MTC-PDCCH or M-PDCCH), EPDCCH, narrow band (NB)-EPDCCH, NB-PDCCH, and low cost machine-type communication physical downlink control channel (LC-MTC-PDCCH) may be used interchangeably herein for the DL control channel transmitted in the certain D-subband.

In an example, a BW limited WTRU may be configured with multiple DL subbands but the WTRU may only be able to receive a DL signal in one subband in a subframe. However, if a DL control channel is transmitted in two or more subbands in the same subframe, the WTRU may miss one or more DL control channels.

In a further example, a WTRU may be configured with two or more DL subbands and one of the configured DL subband may be used for NB-EPDCCH, wherein the DL subband used for NB-EPDCCH may be determined as a function of at least one of WTRU-ID, subframe number, radio frame number, a partitioned PRACH resource used, and a coverage enhancement level.

An NB-EPDCCH may be categorized into two types such as USS and CSS, where the NB-EPDCCH USS may be the DL control channel carrying WTRU-specific information and the NB-EPDCCH CSS may be the DL control channel carrying common information. Therefore, an NB-EDPCCH may be NB-EPDCCH USS, NB-EPDCCH CSS, or both.

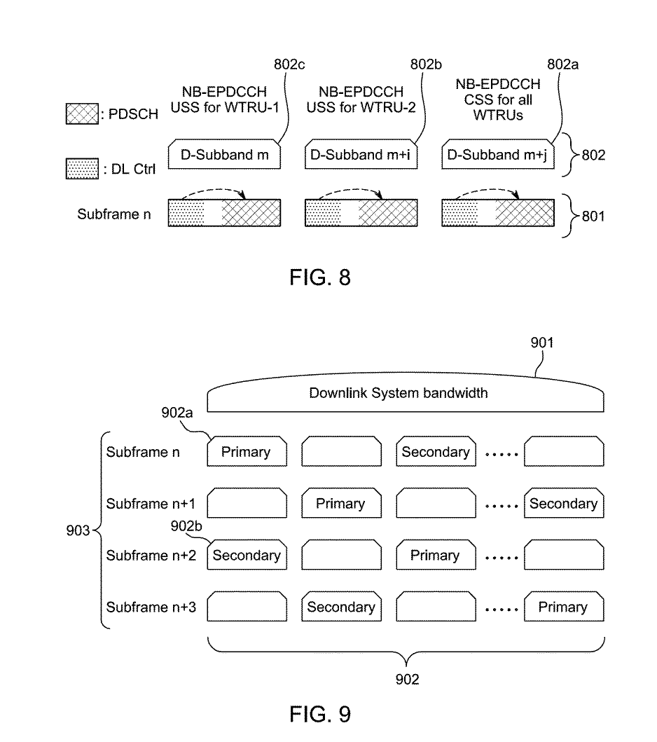

FIG. 8 is a diagram of an example of NB-EPDCCH USS/CSS configuration with a subframe n 801 and multiple D-subbands 802 configured therein. DL control (Ctrl) information via a control channel (e.g., PDSCH) and its corresponding data via a data channel (e.g., PDSCH) are configured to be received and/or received by the WTRU during a same subframe and a same D-subband. As used herein, terms received and configured to be received may be used interchangeably.

The NB-EPDCCH USS may carry the same or a subset of information carried in the legacy (E)PDCCH USS and the NB-EPDCCH CSS may carry the same or a subset of information carried in the legacy (E)PDCCH CSS. NB-EPDCCH USS may be used by the WTRU for one or more of following: monitoring a downlink control information (DCI) with a cyclic redundancy check (CRC) scrambled with a C-RNTI; receiving ACK/NACK corresponding to a UL transmission; and receiving a PDSCH containing paging, RAR, or SIB without an associated control channel.

NB-EPDCCH CSS may be used by the WTRU for one or more of following: monitoring a DCI with a CRC scrambled with a P-RNTI; monitoring a DCI with a CRC scrambled with an RA-RNTI; monitoring a DCI with a CRC scrambled with a system information radio network identifier (SI-RNTI); and receiving a PDSCH containing paging, RAR, or SIB without an associated control channel. The NB-EPDCCH USS and the NB-EPDCCH CSS may be fully or partially overlapped in the same D-subband. In a further example, the NB-EPDCCH may be used only for the WTRU-specific search space and all DCIs may be monitored in the NB-EPDCCH USS.

In an example, multiple D-subbands 802 may be configured via a broadcasting channel (e.g., LC-SIB) and one of the configured D-subbands may be used as a DC-subband 802a for NB-EPDCCH CSS. The DC-subband 802a associated with NB-EPDCCH CSS may be referred to as a primary DC-subband. The primary DC-subband may be determined based on at least one of the following parameters: a physical cell-ID, the number of D-subbands configured or used, and a DL system BW indicated from an MIB.

The primary DC-subband may be indicated from a broadcasting channel (e.g., LC-SIB). Therefore, the broadcasting channel may indicate the D-subbands configurations and the DC-subband associated with NB-EPDCCH CSS. The primary DC-subband may be a D-subband having a lowest or a highest index in the configured D-subbands.

The primary DC-subband may be implicitly determined as a function of the PRACH resource used for a PRACH preamble transmission. For example, two or more PRACH resources may be partitioned (e.g., using time division multiplexing (TDM), frequency division multiplexing (FDM), and/or code division multiplexing CDM)) into multiple subsets and each subset (e.g., each partitioned PRACH resource) may be associated with a DC-subband. The partitioned PRACH resource may correspond to a coverage enhancement level. For example, a first partitioned PRACH resource may be associated with a normal coverage level (e.g., CE level-0) and a second partitioned PRACH resource may be associated with a coverage enhancement level 1 (e.g., CE level-1), and so on. The partitioned PRACH resource may be associated with a mode of operation. For example, a first partitioned PRACH resource may be associated a normal mode of operation and a second partitioned PRACH resource may be associated with a coverage enhanced mode of operation.

The primary DC-subband may be predefined as a D-subband located in the center 6 PRB-pairs. A WTRU may also receive PSS/SSS and PBCH in the primary DC-subband.

In another example, multiple D-subbands 802 may be configured via a broadcasting channel (e.g., LC-SIB) and at least one of the configured D-subbands (e.g., D-subband 802b and 802c) may be used as a DC-subband for NB-EPDCCH USS. The DC-subbands 802b and 802c associated with NB-EPDCCH USS may be referred to as secondary DC-subbands.

The secondary DC-subband may be determined based on at least one of the following parameters: a physical cell-ID, the number of D-subbands configured or used, the D-subband index used for a primary DC-subband, a DL system BW indicated from an MIB, and a WTRU-ID. The secondary DC-subband may be indicated during RACH procedures (e.g., msg2 or msg4).

The secondary DC-subband may be implicitly determined as a function of the PRACH resource used for a PRACH preamble transmission. For example, two or more PRACH resources may be partitioned (e.g., using TDM, FDM, and/or CDM) into multiple subsets and each subset (e.g., each partitioned PRACH resource) may be associated with a DC-subband. The partitioned PRACH resource may correspond to a coverage enhancement level. For example, a first partitioned PRACH resource may be associated with a normal coverage level (e.g., CE level-0) and a second partitioned PRACH resource may be associated with a coverage enhancement level 1 (e.g., CE level-1), and so on. The partitioned PRACH resource may be associated with a mode of operation. For example, a first partitioned PRACH resource may be associated a normal mode of operation and a second partitioned PRACH resource may be associated with a coverage enhanced mode of operation. The secondary DC-subband may be indicated via a higher layer signaling.

In another example, multiple D-subbands 802 may be configured via a broadcasting channel and at least one of the configured D-subbands may be used as a primary DC-subband and at least one of the configured D-subbands may be used as a secondary DC-subband. In this case, one or more of following may apply.

The primary DC-subband may be determined as a function of at least one of the system parameters. The secondary DC-subband may be determined as a function of the PRACH resource used for a PRACH preamble transmission. Also, the secondary DC-subband may be indicated via higher layer signaling. Further, the secondary DC-subband may be determined as a function of at least one of the WTRU-specific parameters (e.g., WTRU-ID, C-RNTI).

The primary DC-subband may be fixed to a D-subband located in a certain location (e.g., center 6 PRBs). The secondary DC-subband may be determined as a function of the PRACH resource used for a PRACH preamble transmission. Also, the secondary DC-subband may be indicated via higher layer signaling. Further, the secondary DC-subband may be determined as a function of at least one of the WTRU-specific parameters (e.g., WTRU-ID, C-RNTI).

The primary DC-subband and secondary DC-subband may be configured in a non-overlapped subframes and/or radio frames 801. For example, the primary DC-subband may be configured in a first subset of subframes and/or radio frames and the secondary DC-subband may be configured in a second subset of subframes and/or radio frames. The first subset of subframes and/or radio frames and the second subset of subframes and/or radio frames may be mutually exclusive, therefore there may be no subframe containing both primary and secondary DC-subbands. The primary DC-subband and the secondary DC-subband may be located in a same D-subband.

FIG. 9 is a diagram of an example of LD-subband and PD-subband mapping for primary and secondary DC-subbands. FIG. 9 shows a DL system bandwith 901 that includes multiple subbands 902 configured in multiple subframes 903. Each subframe 903 includes at least a primary DC-subband 902a and a secondary DC-subband 902b in different frequency locations with respect to other subframes 903. A primary DC-subband 902a and/or a secondary DC-subband 902b may be defined as a logical D-subband (LD-subband) and the mapping rule between the LD-subband and physical D-subband (PD-subband) may be predefined or preconfigured. Additionally or alternatively, a primary DC-subband 902a and a secondary DC-subband 902b may be defined in different LD-subbands. FIG. 9 shows an example of the mapping between LD-subband and PD-subband for the primary and secondary DC-subbands.

In an example, a BW limited WTRU may be configured with multiple DL subbands and two different types of DL control channels (e.g., NB-EPDCCH USS and NB-EPDCCH CSS) may be located in a different DL subbands. Since the WTRU only receives one DL subband at a time, the WTRU may be not able to receive one of the DL control channels.

In a further example, a WTRU may be configured with a first subband for NB-EPDCCH CSS and a second subband for NB-EPDCCH USS, and, if the WTRU is configured to monitor NB-EPDCCH CSS and NB-EPDCCH USS in a same subframe. A priority rule may be used to determine which subband within the subframe to monitor if the first subband is located in a different frequency location from that of the second subband. Otherwise, the WTRU may monitor both subbands.

In another example, the primary DC-subband may be configured in a subset of subframes or radio frames while the secondary DC-subband may be configured in all DL subframes. In a subframe containing both primary and secondary DC-subbands, one or more of following may apply.

If the primary DC-subband and the secondary DC-subband are in different frequency locations (e.g., different physical D-subbands or different L-subbands) then a priority rule may apply. For example, the primary DC-subband may have a higher priority than the secondary DC subbands. The primary DC-subband carrying a certain DL channel may have a higher priority than the secondary DC subband. For example, the primary DC-subband carrying a broadcasting channel (e.g., LC-SIB) may have a higher priority than the secondary DC subband while the primary DC-subband carrying another signal may have a lower priority than the secondary DC subband.

If the primary DC-subband and the secondary DC-subband are in different frequency locations (e.g., different physical D-subbands or different L-subbands) then a switching rule may be applied. A switching time (e.g., frequency retuning time) may be applied if a WTRU needs to change from a first D-subband (or first PD-subband) to a second D-subband (or second PD-subband), where the first and second D-subbands may be located in different frequency locations. The switching time may be applied for a subframe next to the subframe containing the second D-subband. For example, if the subframe n contains the second D-subband, then the subframe n-1 and/or the subframe n+1 may contain the switching time. In a subframe containing switching time, a WTRU may skip monitoring or receiving a DL control channel. In a further example, a WTRU may skip receiving one or more of orthogonal frequency-division multiplexing (OFDM) symbols in the subframe.

If the primary DC-subband and the secondary DC-subband are in the same frequency location (e.g., the same physical D-subband or same L-subband) then a WTRU may monitor or receive DL control channels in both DC-subbands.

An association between control and data channels may be used. In an example, there may be in-subframe control channel and data channel association with one or more D-subbands such that a control channel associated with a data channel is located in the same subframe. In contrast, there may be cross-subframe control channel and data channel association with one or more D-subbands such that associated control and data channels are located in different subframes. As used herein, the terms in-subframe association and same-subframe association and in-subframe control channel and data channel association may be used interchangeably. Similarly, the terms cross-subframe association and different-subframe association and cross-subframe control channel and data channel association may be used interchangeably

In an example, a BW limited WTRU may be configured with multiple DL subbands and, if the DL subband is changed from one subframe to another, the WTRU may not be able to receive partial or full subframe next to the subframe where the subband location is changed since it may need a frequency retuning time (which may be up to 1 ms).

In a further example, a WTRU may determine a DL subband within a plurality of DL subbands configured in a first subframe and the WTRU may monitor a DL control channel in the determined DL subband in the first DL subframe if the determined DL subband for the first subframe and a second subframe is the same, wherein the second subframe may be a subframe next to the first subframe.

In an example, two or more D-subbands may be configured for PDSCH transmission and a WTRU may monitor and/or receive a DL control channel and the associated PDSCH in the same D-subband. In this case, one or more of following may apply.

Two or more transmission modes may be used. For example, a frequency hopping mode and a non-frequency hopping mode may be defined. As used herein, the terms frequency hopping mode, frequency diversity mode, and distributed resource allocation mode may be used interchangeably. The terms non-frequency hopping mode, localized mode, and frequency selective scheduling mode may be used interchangeably.

A WTRU may be configured with a frequency hopping mode with two or more configured D-subbands and one of the configured D-subbands may be selected or determined in each subframe for a DL signal reception. Therefore, D-subband may be changed from a subframe to another. The determination of the D-subband may be based on at least one of a subframe number and/or radio frame number, the number of the configured D-subband(s), the WTRU-ID and a frequency hopping sequence.

In a non-frequency hopping mode, a D-subband may be configured in a semi-static manner (e.g., with a single subband). The D-subband may be determined by at least one of following.

A higher layer signaling may be used to configure the D-subband. Therefore, the D-subband may be determined in a WTRU-specific manner.

A WTRU-ID (e.g., C-RNTI) may be used to determine the D-subband. For example, the D-subband may be determined as a function of C-RNTI. A PRACH resource used for a PRACH preamble transmission may determine the D-subband.

In a frequency hopping mode of operation, a WTRU may monitor or receive a DL control channel in a subset of subframe and/or radio frame. The subframe in which the WTRU may not receive or monitor a DL control channel may be determined by at least one of following.

A higher layer signaling may indicate the subframes. Also, the subframe may be determined based on a predefined condition which may be based on the frequency hopping. For example, the predefined condition may be an adjacent subframe next to the subframe in which the D-subband location is changed from a previous D-subband location. In an example, if a WTRU received or monitored a downlink signal in a subframe n in the D-subband m and the WTRU may need to receive or monitor a downlink signal in a subframe n+k in the D-subband m+i, the subframe next to the subframe n+k (e.g., the subframe n+k−1 and/or the subframe n+k+1) may be the adjacent subframe.

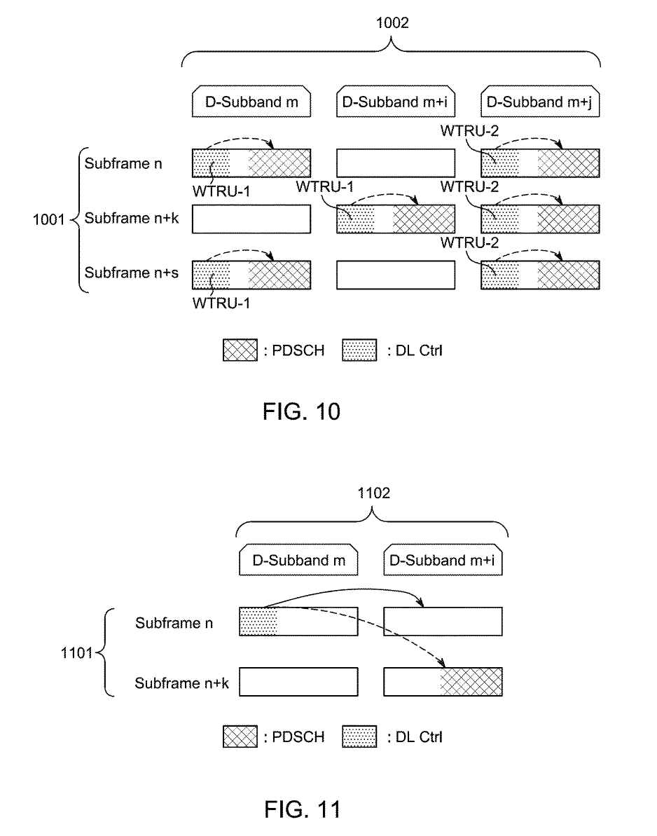

FIG. 10 is a diagram of an example in-subframe association with subframes 1001 configured with multiple subbands 1002. FIG. 10 shows an example of in subframe control channel and data channel association with and without a frequency hopping, where a WTRU-1 may be configured with a frequency hopping mode of operation with two configured D-subbands (e.g., D-subbands m and m+i) and a WTRU-2 may be configured with a non-frequency hopping mode with one configured D-subband (e.g., D-subband m+j). Accordingly, WTRU 1 receives multiple associated control and data signal pairs using multiple D-subbands across multiple subframes, and WTRU 2 receives multiple associated control and data signal pairs using one D-subband across multiple subframes.

In another example, a WTRU may determine a D-subband within the configured multiple D-subbands configured in a first subframe and the WTRU may monitor a downlink control channel (e.g., NB-EPDCCH) in the determined downlink subband in the first downlink subframe, if the determined downlink subband for the first subframe and a second subframe is the same, where the second subframe may be a subframe next to the first subframe.

The first subframe may be the subframe n. The second subframe may be a subframe n−1 and/or a subframe n+1. The subframe in which a WTRU may skip receiving or monitoring a downlink control channel may be considered as a guard subframe for frequency band switching.

In an example, cross-subframe control channel and data channel association with multiple subbands may be used. As used herein, the terms cross-subframe association, cross-subframe control channel and data channel association may be used interchangeably.

According to cross-subframe association, a downlink control channel may be monitored and/or received by a WTRU in a first subframe and an associated data channel (e.g., PDSCH) may be received in a second subframe, where the downlink control channel and the associated data channel may be in a same D-subband and/or in a different D-subband. In an example, the downlink control channel in the first subframe may carry a DCI which may contain the scheduling information of the associated PDSCH in the second subframe. The DCI may include one or more of following information.

FIG. 11 is a diagram of an example of cross-subframe scheduling indication from DCI. FIG. 11 shows subframes 1101 configured with multiple subbands 1102. The DCI may include a frequency location of the PDSCH in the second subframe. At least one of the following information may be provided to a WTRU to indicate the frequency location of the associated PDSCH in the second subframe. The PRB-pair locations of the D-subband may be provided. A D-subband index may be indicated. An offset of the D-subband index from the current D-subband where the DCI may be received. For example, in FIG. 11, the current D-subband is m and the offset for the D-subband where the associated PDSCH is transmitted is i. A starting PRB-pair number may be indicated. The starting PRB-pair number may be a subset of PRB-pair number within a system BW.

The PRB-pair locations of the associated PDSCH within the D-subband may be provided. The PRB-pairs allocated for the associated PDSCH may be indicated from the DCI.

The DCI may include a time location of the second subframe. The time location may be indicated by an offset. For example, if the first subframe is located in the subframe n and the second subframe for the associated PDSCH reception is located in the subframe n+k, where the k may be indicated from the DCI. In this case, the k may be considered as an offset.

The time location may be determined as a function of at least one of an offset parameter in the DCI and the frequency location of the associated PDSCH. For example, if the first subframe is located in the subframe n and the frequency location of the associated PDSCH is in a same D-subband where the WTRU received the DCI, the second subframe may be located in the n+k. However, if the frequency location of the associated PDSCH is in a different D-subband from the subband where the WTRU received the DCI, the second subframe may be located in the n+k+δ. The k may be indicated from the DCI. The δ may be a predefined number. For example, δ=1. The δ may be considered as a frequency retuning time.

The time location (e.g., k) may be determined as a function of the frequency location of the D-subband containing the associated PDSCH. The time location k may be a predefined number k1 if the subband containing the associated PDSCH is the same as the subband where the WTRU received corresponding DCI. Otherwise, k2 may be used. The time location k1 and the time location k2 may be a different number. The time location k may be determined as a function of the subband index.

The time location may be determined based on the subframe type of a certain subframe which may have a fixed timing relation with the first subframe. For example, the first subframe may be located in the subframe n where a WTRU may receive a DCI and the certain subframe which may have a fixed timing relation may be located in the subframe n+k. In this case, the time location of the second subframe may be determined as a function of the subframe type of the subframe n+k. The second subframe may be located in n+k+δ, where the δ may be determined as a function of the subframe type of the subframe n+k. In an example, δ=0, if the subframe n+k is the subframe type A, and δ>0, if the subframe n+k is the subframe type B, where the subframe type A may be a subframe in which PDSCH can be transmitted and the subframe type B may be a subframe in which PDSCH cannot be transmitted. In another example, the subframe type A may be a normal subframe in which a PDSCH may be transmitted and the subframe type B may be a subframe used for at least one of a physical multicast channel (PMCH), uplink, and retuning.

The time location may be determined based on the location of the next available subframe for a PDSCH transmission later than a certain timing offset. For example, the first subframe may be located in the subframe n where a WTRU may receive a DCI and the certain timing offset may be k-1, where k may be a predefined number, configured via higher layer signaling, or broadcasted. Therefore, if the subframe k is an available subframe for a PDSCH transmission, the time location of the second subframe where the WTRU may receive the associated PDSCH may be the subframe n+k. If the subframe k is not an available subframe for a PDSCH transmission and the subframe k+δ is the next available subframe for a PDSCH transmission, the time location of the second subframe where the WTRU may receive the associated PDSCH may be the subframe n+k+δ, where the subframe which may be not an available subframe for a PDSCH transmission may be at least one of but not limited to an MBSFN subframe carrying PMCH, an uplink subframe, a special subframe, and a guard subframe which may be used for retuning.

In another example, the frequency locations of the D-subband for the first subframe and the second subframe may be predetermined or preconfigured. In this case, one or more of following may apply.

A frequency hopping pattern for the D-subband hopping may be used to determine the D-subband frequency location (e.g., D-subband index) in a subframe in which a WTRU may monitor or receive a downlink signal. A set of frequency hopping patterns may be predefined and one of the frequency hopping patterns may be determined and/or selected by the network based on at least one of WTRU-ID (e.g., C-RNTI), a WTRU group ID which may be configured by higher layer, a mode of operation (e.g., normal coverage mode, coverage enhanced mode), and a coverage enhancement level. Also, one of the frequency hopping patterns may be determined by a higher layer configuration (e.g., an RRC configuration). In addition, one of the frequency hopping patterns may be determined as a function of a PRACH resource used for a PRACH preamble transmission, where the PRACH resource may be partitioned into two or more subsets and each subset may be associated with a frequency hopping pattern.

The frequency hopping patterns may include a non-frequency hopping case in which the same D-subband may be used in all subframes. The frequency hopping patterns may include a guard subframe in which a WTRU may not receive or monitor a downlink signal.

A frequency hopping pattern may be defined based on a subframe number in a radio frame or radio frame number. In an example, if multiple D-subbands are configured for D-subband hopping, {n0, n1, n2, n3, n4, n5, n6, n7, n8, n9} may be used as a frequency hopping pattern based on a subframe number, where the first number (e.g., n0) may be a D-subband index for the first subframe in a radio frame and the second number (e.g., n1) may be a D-subband index for the second subframe in a radio frame, and so on.

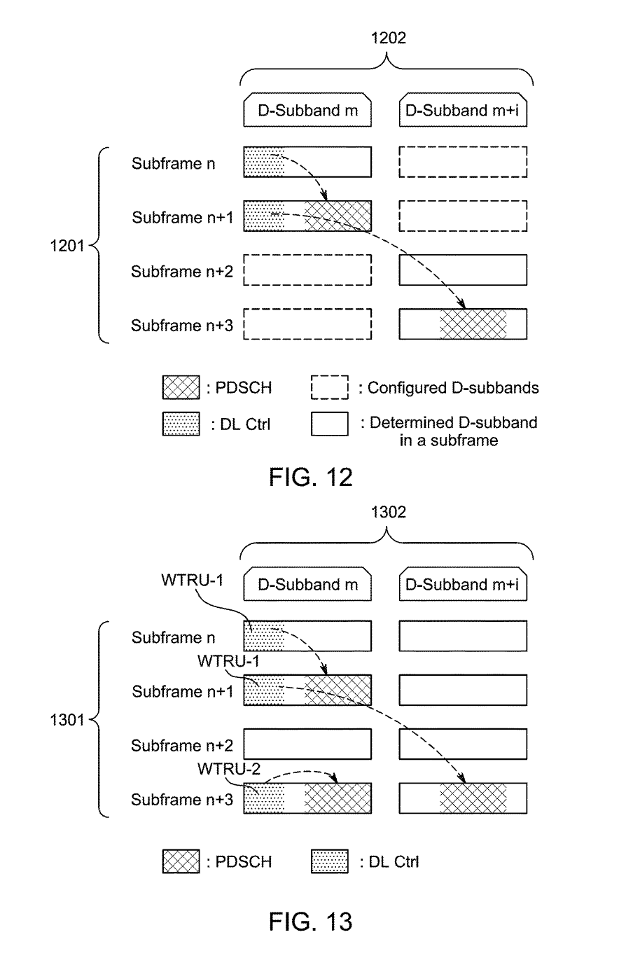

FIG. 12 is a diagram of an example of the offset k according to the D-subband frequency location of the second subframe. FIG. 12 shows subframes 1201 configured with multiple subbands 1202. In an example, an offset may be used to determine association between the first subframe and the second subframe. For example, if the first subframe is located in the subframe n, the second subframe may be located in the subframe n+k, where the k may be considered as the offset.

The offset k may be a fixed number. The offset k may be indicated from a DCI. The offset k may be 0, which may be considered as in-subframe association. If k>0, a cross-subframe association may be used.

The offset k may be determined based on predefined conditions. The offset k may be 1, if the frequency location of the D-subband (e.g., D-subband index) is the same for both first subframe and second subframe, and may be considered a base offset value. The offset k may be a predefined number greater than the base offset value (e.g., 2 or 3), if the frequency location of the D-subband (e.g., D-subband index) is different for the first subframe and the second subframe. For example, FIG. 12 shows different offsets for an inter-frequency association and an intra-frequency association for receiving associated control signals and data signals. In particular, in the same frequency, a data channel in subframe n+1 is associated with a control channel in subframe n is offset by one subframe. On the other hand, in different frequencies, a data channel in subframe n+3 associated with a control channel in subframe n+1 is offset by two subframes.

A D-subband within the configured D-subbands may be determined in a subframe and a WTRU may monitor or receive a downlink control channel in the D-subband. If a WTRU receives a DCI for PDSCH scheduling, the subframe may become the first subframe and the D-subband for the second subframe may be determined based on the second subframe time location.

In another example, the frequency location of the D-subband for the first subframe may be predetermined or preconfigured and the frequency location of the D-subband for the second subframe may be indicated from the downlink control channel in the first subframe. In this case, one or more of following may apply.

Two or more D-subbands may be configured and one of the configured D-subband may be used as NB-EPDCCH (e.g., DC-subband). The DC-subband may be used for NB-EPDCCH USS and/or NB-EPDCCH CSS. The DC-subband may be configured via higher layer signaling or a broadcasting channel. A WTRU may monitor or receive a DCI with C-RNTI in the DC-subband only.

A WTRU may receive or monitor a DCI with C-RNTI in the subframe which may satisfy one or more of following conditions. A subframe may satisfy a condition that a subframe be configured to include a DC-subband. A subframe may satisfy a condition that a subframe may not be used for a PDSCH reception in a D-subband of which frequency location may be different from that of the DC-subband. A subframe may satisfy a condition that a subframe may not be used for a reception of a downlink signal which may have a higher priority than the DCI with C-RNTI in a D-subframe of which frequency location may be different from that of the DC-subband.

FIG. 13 is a diagram of an example of the offset k according to the D-subband frequency location of the second subframe for multiple WTRUs (e.g., WTRU1 and WTRU2). FIG. 13 shows subframes 1301 configured with multiple subbands 1302. The offset k may be 0, which may be considered as in-subframe association. If offset k>0, a cross-subframe association may be used, where the offset k for a cross-subframe association may be greater than an offset k for an in-subframe association.

For example, The offset k may be 0, if the associated control and data signals are received in the same subframe and if the frequency location of the D-subband (e.g., D-subband index) is the same for both received signals, and may be considered a base offset value. FIG. 13 shows that the offset k is 0 for WTRU 2 for the associated control and data signals received in subframe n+3, D-subband m (i.e., an in-subframe association).

For WTRU 1, FIG. 13 shows that the offset k may be 1, if the frequency location of the D-subband (e.g., D-subband index) is the same for both first subframe and second subframe (i.e., cross-subframe association), and may be considered a base offset value for a cross-subframe association. The offset k may be a predefined number greater than the base offset value for a cross-subframe association (e.g., 2 or 3), if the frequency location of the D-subband (e.g., D-subband index) is different for the first subframe and the second subframe (i.e., cross-subframe association). FIG. 13 shows that the offset k is 1 for WTRU 1 for a cross-subframe association within a same D-subband (e.g., the control signal received by WTRU 1 in subframe n, D-subband m and the data signal received by WTRU 1 in subframe n+1, D-subband m). In addition, the offset k is 2 for WTRU 1 for a cross-subframe association occurring over different D-subbands (e.g., the control signal received by WTRU 1 in subframe n+1, D-subband m and the data signal received by WTRU 1 in subframe n+3, D-subband m+i).

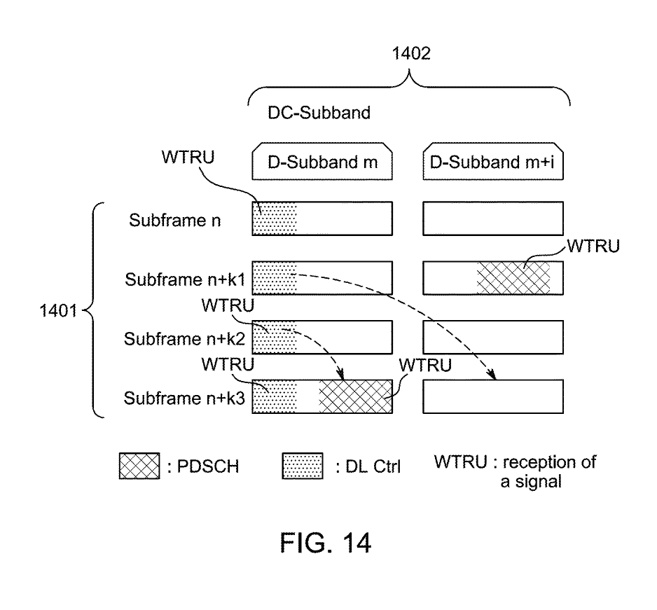

FIG. 14 is a diagram of an example of a WTRU reception behavior with cross-subframe association. FIG. 14 shows subframes 1401 configured with multiple subbands 1402 in which a DL control signal received by the WTRU in subframe n, D-subband m is associated with a DL data signal received by the WTRU in subframe n+k1, D-subband m+i, and a DL control signal received by the WTRU in subframe n+k2, D-subband m is associated with a DL data signal received by the WTRU in subframe n+k3, D-subband m. Thus, FIG. 14 shows an example of the cross-subframe association between control channel and data channel when the frequency location of the D-subband for the first subframe may be predetermined or preconfigured, where the D-subband m is configured as a DC-subband.

In an example, a WTRU may skip monitoring and/or receiving NB-EPDCCH if the WTRU receives an associated PDSCH in a D-subband which is different from the DC-subband in a subframe. In a further example, a WTRU may monitor and/or receive NB-EPDCCH if the WTRU receives a PDSCH in a DC-subband in a subframe. In another example, a WTRU may monitor and/or receive NB-EPDCCH if no downlink signal is allocated in the other D-subband in a subframe.

In another example, a hybrid control channel and data channel association method with multiple subbands may be used. Two or more D-subbands may be configured and one of the configured D-subbands may be used for NB-EPDCCH USS and one of the configured D-subbands may be used for NB-EPDCCH CSS.

In yet another example, a BW limited WTRU may be configured with multiple downlink subbands and two different types of downlink control channels (e.g., NB-EPDCCH USS and NB-EPDCCH CSS) may be located in different downlink subbands. Since the WTRU only receives one downlink subband at a time, the WTRU may be not able to receive one of the downlink control channel and the cross-subframe association used for both may decrease the WTRU throughput performance.

In a further example, a WTRU may be configured with a first subband for NB-EPDCCH CSS and a second subband for NB-EPDCCH USS and the subframe association type (e.g., in-subframe association or cross-subframe association) may be determined based on the NB-EPDCCH search space the WTRU monitors in the subband.

In an example, an in-subframe association or a cross-subframe association may be used based on the NB-EPDCCH search space. If a WTRU receives a DCI in the NB-EPDCCH USS, a cross-subframe association where the control channel and data channel may be received in a different subframe may be used. If a WTRU receives a DCI in the NB-EPDCCH CSS, an in-subframe association where the control channel and data channel may be received in a same subframe may be used.

The D-subband for NB-EPDCCH USS and the D-subband for NB-EPDCCH CSS may be different. A D-subband index may be used to determine the subframe association type (e.g., in-subframe association or cross-subframe association). A D-subband containing downlink control channel type (e.g., NB-EPDCCH USS or NB-EPDCCH CSS) may be used to determine the subframe association type. The D-subband for NB-EPDCCH USS and the D-subband for NB-EPDCCH CSS may be the same.

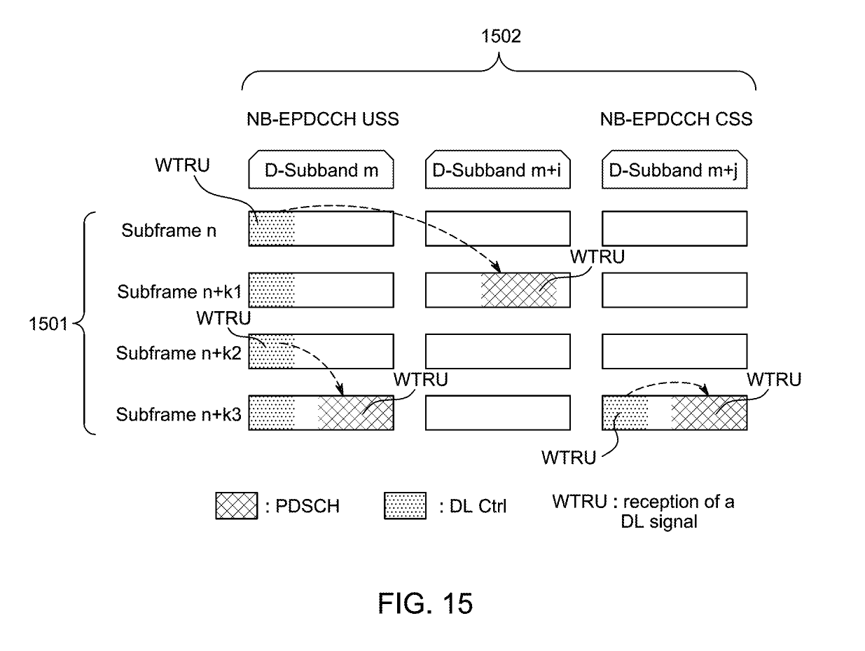

FIG. 15 is a diagram of an example of a D-subband configuration for NB-EPDCCH USS and NB-EPDCCH CSS. FIG. 15 shows an example of subframes 1501 configured with multiple subbands 1502 having a D-subband configuration for NB-EPDCCH USS and NB-EPDCCH CSS with in-subframe association and cross-subframe association. In an example, a cross-subframe association may be used for NB-EPDCCH USS and an in-subframe association may be used for NB-EPDCCH CSS, or vice-versa. Accordingly, a DL control signal received by the WTRU in subframe n, D-subband m is associated with a DL data signal received by the WTRU in subframe n+k1, D-subband m+i, a DL control signal received by the WTRU in subframe n+k2, D-subband m is associated with a DL data signal received by the WTRU in subframe n+k3, D-subband m, and a DL control signal received by the WTRU in subframe n+k3, D-subband m+j is associated with a DL data signal received in subframe n+k3, D-subband m+j.

In another example, an in-subframe association or a cross-subframe association may be used according to the D-subband. Each D-subband may be configured with either in-subframe association or cross-subframe association. The configuration may be based on a higher layer signaling or a broadcasting channel.

A primary D-subband may be predefined or preconfigured as in-subframe association or cross-subframe association. A secondary D-subband may be configured with either in-subframe association or cross-subframe association via higher layer signaling.

A subframe association type may be indicated via broadcasting channel for a primary D-subband, while a subframe association type for a secondary D-subband may be configured via higher layer signaling. Alternatively, a subframe association type for a secondary D-subband may be indicated from a DCI. For example, an offset k may be used in a DCI in which the offset k may indicate in-subframe association (k=0) and cross-subframe association (k>0).

In another example, an in-subframe association or a cross-subframe association may be used based on a WTRU capability (see e.g., FIG. 13). A reduced BW WTRU with a full duplex capability may use a cross-subframe association while a reduced BW WTRU with a half-duplex capability (HD-FDD) may use an in-subframe association. A reduced BW WTRU operating in FDD and/or TDD mode may support a cross-subframe association or both. A reduced BW WTRU with a HD-FDD capability may use an in-subframe association.

The HD-FDD type may determine the subframe association. For example, a first type of HD-FDD (e.g., two oscillators, one for transmitting (Tx) and one for receiving (Rx)) may use the cross-subframe association while a second type of HD-FDD (e.g., a single oscillator for both Tx and Rx) may use an in-subframe association. The first type and the second type of HD-FDD may be determined based on the number of oscillators used. For example, the first type of HD-FDD may use two oscillators for Tx and Rx and the second type of HD-FDD may use a single oscillator for Tx and Rx. The first type and the second type of HD-FDD may be determined based on the switching time for subband hopping.

A reduced BW WTRU may indicate to the network (e.g., a eNode-B) in a signal at least one of the cross-subframe association and the in-subframe association. A WTRU may indicate to the network (e.g., a eNode-B) in a signal a supported subframe association type.

It will be appreciated that methods described herein for configuring D-subbands and applying the configuration to one or more WTRUs may be combined with one or more of any other method described herein for configuring D-subbands and applying the configuration to one or more WTRUs.

In an example, an association between multiple D-subbands and multiple U-subbands may be used. Two or more U-subbands may be configured for a WTRU and the WTRU may transmit an uplink signal in a certain U-subband in a subframe. The two or more U-subbands may be associated with one or more D-subbands. Similar principles described above for configuring D-subbands may be applied for configuring U-subbands.

In a further example, a BW limited WTRU may be configured with multiple downlink subbands and multiple uplink subbands. However, the WTRU may not know which subband to use for an uplink signal transmission or a downlink signal reception.

In another example, a WTRU may be configured with two or more of uplink subbands and the WTRU may transmit an uplink signal in a determined uplink subband in a subframe, wherein the uplink subband may be determined based on the downlink subband the WTRU received associated DCI. In a further example, a WTRU may be configured with two or more of uplink subbands and the WTRU may transmit an uplink signal in a determined uplink subband in a subframe, wherein the uplink subband may be indicated from the associated DCI.

In an example, a certain U-subband for one or more uplink channels (e.g., PUCCH, PUSCH, and the like) may be determined as a function of the D-subband in which the WTRU received an associated DCI. The D-subband index may be used to determine the certain U-subband where a WTRU may transmit an uplink signal allocated by the associated DCI. For example, if a WTRU receives a DCI with C-RNTI for an uplink grant in a D-subband x, the D-subband index x may be used to determine the U-subband index in which an uplink resource may be allocated.

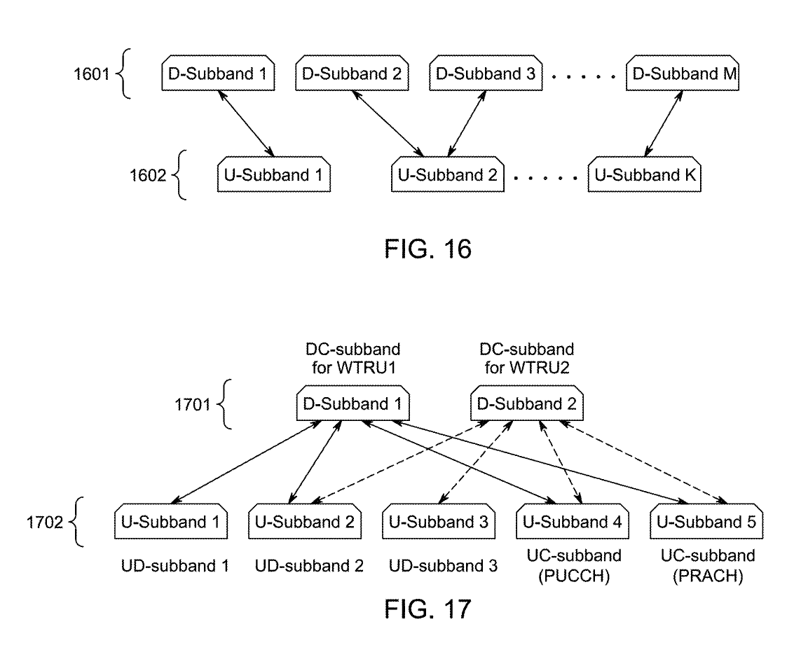

FIG. 16 is a diagram of an example of D-subband and U-subband linkage in a system configured with multiple D-subbands 1601 and multiple U-subbands 1602. A D-subband 1601 may be preconfigured with a U-subband 1602 for one or more uplink channels. Each D-subband 1601 carrying a DCI used for an uplink resource allocation (e.g., for PUSCH and PUCCH) may be preconfigured with one or more of U-subbands 1602. This may be considered as an example of a preconfigured linkage between D-subband 1601 and U-subband 1602. FIG. 16 shows an example of the linkages between multiple D-subbands 1601 and multiple U-subbands 1602.

FIG. 16 shows that D-subband 1 is linked to U-subband 2, D-subband 2 is linked to U-subband 2, D-subband 3 is also linked to U-subband 2, and D-subband M is linked to U-subband K.

The linkage may be configured or predetermined according to the downlink and/or uplink channel. For example, a D-subband may be linked with a first U-subband for an uplink channel (e.g., PUSCH) and a second U-subband for another uplink channel (e.g., PUCCH). The linkage between a D-subband and a plurality of U-subbands may be predefined or configured via a broadcasting channel (e.g., LC-SIB) or a higher layer signaling.

In another example, the certain U-subband for one or more uplink channels (e.g., PUCCH, PUSCH) may be indicated from an associated DCI for uplink resource allocation. A DCI used for uplink resource allocation may include an indication of the U-subband index. The uplink resource allocation field may be defined to indicate both the U-subband index and the uplink resource allocated within the U-subband.

In another example, a WTRU may be configured with two or more U-subbands for a certain uplink channel (e.g., PUSCH transmission) and one of the configured U-subbands for the certain uplink channel may be determined by at least one of following: an indication from the associated DCI, and/or as a function of at least one of a subframe number, a radio frame number, and WTRU-ID.

As used herein, a U-subband used for PUSCH transmission may be referred to as an uplink data subband (UD-subband) and a U-subband used for PUCCH and PRACH may be referred to as an uplink control subband (UC-subband).

FIG. 17 is a diagram of an example of a common UC-subband with a WTRU-specific UD-subbands configuration. In particular, FIG. 17 shows D-subbands 1701 linked to U-subbands 1702. FIG. 17 shows an example of a common UC-subband with a WTRU-specific UD-subbands configuration, where a WTRU may be configured with a DC-subband and the DC-subband may be associated with a set of UD-subbands and UC-subbands. The UD-subbands may be determined as a function of the DC-subband frequency location while the UC-subbands may be preconfigured or be common for all DC-subbands.

In particular, FIG. 17 shows that a DC-subband for WTRU 1 (D-subband 1) is linked to U-subbands 1, 2, 4, and 5, and a DC-subband for WTRU 2 (D-subband 2) is linked to U-subbands 2-5. U-subbands 1-3 are UD-subbands, U-subband 4 is a UC-subband used for PUCCH, and U-subband 5 is a UC-subband used for PRACH.

In another example, two or more U-subbands may be configured for a certain uplink channel (e.g., PUCCH) and one of the U-subbands may be determined in a subframe based on one or more of following. One of the U-subbands may be determined in a subframe based on an indication indicated from the associated DCI. One of the U-subbands may be determined in a subframe based on a function of at least one of a subframe number, a radio frame number, WTRU-ID, the number of U-subbands configured for the uplink channel, and the D-subband index where the associated DCI is received. One of the U-subbands may be determined in a subframe based on a function of the starting ECCE index of the NB-EPDCCH candidate where the associated DCI received. One of the U-subbands may be determined in a subframe based on a function of the NB-EPDCCH candidate where the associated DCI is received.

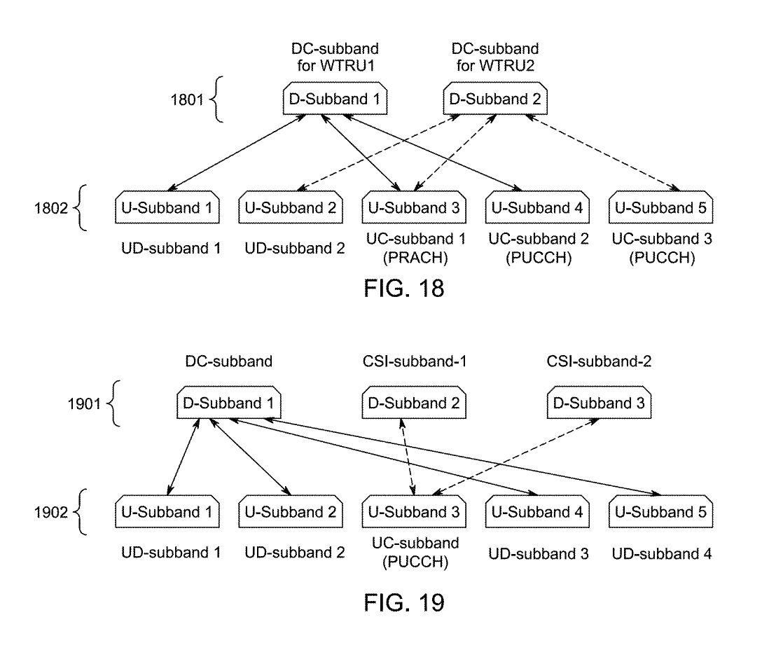

FIG. 18 is a diagram of an example of a multiple UC-subbands configuration for a certain uplink channel and association with multiple DC subbands. In particular, FIG. 18 shows D-subbands 1801 linked to U-subbands 1802. FIG. 18 shows an example of multiple UC-subbands configuration for a certain uplink channel (e.g., PUCCH) and the linkage between the multiple UC-subbands for a certain uplink channel and multiple DC-subbands.

In particular, FIG. 18 shows that a DC-subband for WTRU 1 (D-subband 1) is linked to U-subbands 1, 3, and 4, and a DC-subband for WTRU 2 (D-subband 2) is linked to U-subbands 2, 3, and 5. U-subbands 1 and 2 are UD-subbands, U-subband 3 is a UC-subband used for PRACH, and U-subbands 4 and 5 are UC-subbands used for PUCCH.

In an example, ACK/NACK resource allocation with in-subframe and cross-subframe associations may be used. Further, in an example, an in-subframe association and a cross-subframe association may be used for reduced BW WTRUs; however, the WTRUs may not know which ACK/NACK resource to use in each subframe association case.

In a further example, a WTRU may receive a DCI for a PDSCH resource allocation in a first subframe, the WTRU may receive the allocated PDSCH in a second subframe, and the WTRU may transmit the corresponding ACK/NACK in an allocated uplink resource in a third subframe, wherein the third subframe may be determined as a function of the first subframe if in-subframe association is used and as a function of the second subframe if cross-subframe association is used. For example, a WTRU may receive a DCI in a first subframe and the WTRU may receive an associated PDSCH in a second subframe. Also, the WTRU may transmit the corresponding ACK/NACK in an allocated uplink resource in a third subframe.

In an example, the third subframe may be determined based on a subframe association type. For example, the third subframe may be determined based on the first subframe if in-subframe association is used. On the other hand, the third frame may be determined based on the second subframe if cross-subframe association is used. In this case, one or more of following may apply.

If a WTRU receives a DCI in a first subframe n and the WTRU is configured for in-subframe association, the WTRU may transmit the corresponding ACK/NACK in a third subframe n+k. The offset k may be determined based on a duplex scheme (e.g., FDD or TDD). The offset k may be determined according to the UL/DL subframe configuration and/or subframe number in TDD. The offset k may be determined according to the mode of operation (e.g., normal mode and coverage enhanced mode) and/or coverage enhancement level.

If a WTRU receives a DCI in a first subframe n and the associated PDSCH in a second subframe n+α, the WTRU may transmit the corresponding ACK/NACK in a third subframe n+α+k. In this case, the same offset k may be used for in-subframe association while the second subframe may be used as a reference subframe. The offset k may be determined based on a duplex scheme (e.g., FDD or TDD). The offset k may be determined according to the UL/DL subframe configuration and/or subframe number in TDD. The offset k may be determined according to the mode of operation (e.g., normal mode and coverage enhanced mode) and/or coverage enhancement level.

In another example, the third subframe may be indicated from the associated DCI. For example, if a WTRU receives a DCI in a first subframe n and the associated PDSCH in a second subframe n+α, the WTRU may transmit the corresponding ACK/NACK in a third subframe n+α+k or n+k, where offset k may be indicated from the associated DCI.

In wireless communications, CSI refers to known channel properties of a communication link. This information may describe how a signal propagates from the transmitter to the receiver and represents the combined effect of, for example, scattering, fading, and power decay with distance. The CSI makes it possible to adapt transmissions to current channel conditions, which is crucial for achieving reliable communication with high data rates in multiantenna systems. CSI should be estimated at a receiver and should usually be quantized and fed back to a transmitter (although reverse-link estimation is possible in TDD systems). Therefore, the transmitter and receiver can have different CSI. The CSI at the transmitter and the CSI at the receiver are sometimes referred to as channel information at the transmitter (CSIT) and channel information at the receiver (CSIR), respectively.

Generally, there are two levels of CSI, namely instantaneous CSI and statistical CSI. Instantaneous CSI (or short-term CSI) means that the current channel conditions are known, which can be viewed as knowing the impulse response of a digital filter. This gives an opportunity to adapt the transmitted signal to the impulse response and thereby optimize the received signal for spatial multiplexing or to achieve low bit error rates. Statistical CSI (or long-term CSI) means that a statistical characterization of the channel is known. This description can include, for example, the type of fading distribution, the average channel gain, the line-of-sight component, and the spatial correlation. As with instantaneous CSI, statistical CSI can be used for transmission optimization.

The CSI acquisition is practically limited by how fast the channel conditions are changing. In fast fading systems, where channel conditions vary rapidly under the transmission of a single information symbol, only statistical CSI may be reasonable. On the other hand, in slow fading systems, instantaneous CSI can be estimated with reasonable accuracy and used for transmission adaptation for some time before being outdated. In practical systems, the available CSI may lie in between these two levels; instantaneous CSI with some estimation/quantization error is combined with statistical information.

Multiple subbands may be determined or configured for CSI feedback. Specifically, two or more D-subbands (e.g., two or four) may be determined or configured as a subband for CSI feedback which may include at least one of quality-of-service (QoS) class identifier (CQI), precoding matrix indicator (PMI), and rank indicator (RI). As used herein, the D-subband configured or determined for CSI feedback may be referred to as a CSI-subband. A WTRU may monitor for and/or receive a CSI feedback request in the CSI-subband. The CSI-subband (i.e., D-subband) may be used by the network (e.g., eNode-B) to transmit in the downlink a signal that indicates and/or requests a CSI report (i.e., feedback) from the WTRU. In response to receiving the CSI feedback indication and/or request, the WTRU may perform the requested CSI measurements and transmit the CSI feedback, along with a DL subband index corresponding to a CSI-subband, to the network (e.g., the eNodeB). An associated U-subband to transmit the CSI feedback report may be identified and/or determined by the WTRU (or network) for the reporting, and the WTRU may transmit the CSI feedback report using the identified and/or determined associated U-subband.

Implicit U-subband indication for PUSCH and CSI reporting based on downlink/uplink subband association may be used by a WTRU to determine U-subband(s) to use for PUSCH and/or CSI reporting. For example, D-subband location for USS may indicate to the WTRU the associated U-subband(s) to use for PUSCH and/or CSI reporting.

The number of CSI-subbands may be equal to or smaller than the number of D-subbands configured for a WTRU. For example, N D-subbands may be configured for a WTRU and a subset of the N D-subbands may be configured or determined as CSI-subbands, e.g., M CSI-subbands, where M may be an positive integer number which is equal to or smaller than N.

The subset of D-subbands for the CSI-subbands may be determined based on at least one of following. A higher layer signaling may indicate the subset of D-subbands for CSI feedback. For example, a bitmap may be used to indicate the subset of D-subbands. In another example, all D-subbands configured may be designated as CSI-subbands for CSI feedback. In another example, all D-subbands may be configured as non-CSI-subbands except for a certain D-subband (i.e., a CSI-subband), where the certain D-subband (i.e., the CSI-subband) may be determined and configured on at least one of following conditions. A D-subband where a WTRU may monitor and/or receive a DL control channel (e.g., an EPDCCH) therein may be considered as a CSI-subband. The DL control channel may be at least of one of NB-EPDCCH USS and NB-EPDCCH CSS. The DL control channel may also be an MPDCCH. In another example, a D-subband that contains PSS/SSS and/or PBCH may be determined as a CSI-subband. In a further example, a D-subband that is configured or determined as a cell-common D-subband may be determined as a CSI-subband. For example, the D-subband that may be configured or determined as a paging subband may be considered as a cell-common D-subband and determined as a CSI-subband.

In another example, a DCI may indicate the CSI-subbands, and a non-CSI-subband may be determined by the WTRU explicitly or implicitly by the DCI. The DCI may be carried in at least one of NB-EPDCCH USS and NB-EPDCCH CSS. Further, the CRC of the DCI may be masked with a certain RNTI. For example, CSI-RNTI may be configured to indicate the CSI-subbands, and a non-CSI-subband may be determined explicitly or implicitly therefrom by the WTRU.

CSI feedback may be reported (i.e., transmitted) by the WTRU to a network (e.g., eNobe-B) on a PUCCH for an associated CSI-subband (i.e., a D-subband requesting CSI feedback). In an example, a PUCCH may be used by the WTRU to report a CSI for a certain CSI-subband. For example, PUCCH format 2/2a/2b may be used for CSI feedback corresponding to a certain CSI-subband. In this case, one or more of following may apply.

The U-subband containing the associated PUCCH resource for the CSI reporting may be predefined as a function of CSI-subband index or D-subband index. As an example, a U-subband may be configured for a CSI-subband-1 and another U-subband may be configured for a CSI-subband-2. Therefore, a WTRU may report CSI in the U-subband linked to the corresponding CSI-subband index.

FIG. 19 is a diagram of an example of a configuration of CSI subbands (e.g., one or more D-subbands) and U-subband linkage. In particular, FIG. 19 shows D-subbands 1901 linked to U-subbands 1902. A single U-subband (e.g., U-subband 3—a UC-subband) for a WTRU may be configured for PUCCH transmission and the CSI reporting on PUCCH may be transmitted in the U-subband regardless of the CSI-subband index for which the WTRU may report the CSI as shown in FIG. 19.

In particular, FIG. 19 shows that a DC-subband (D-subband 1) is linked to U-subbands 1, 2, 4, and 5, a first CSI-subband-1 (D-subband 2) is linked to U-subband 3, and a second CSI-subband-2 (D-subband 3) is linked to U-subband 3. U-subbands 1, 2, 4, and 5 are UD-subbands and U-subband 3 is a UC-subband used for PUCCH.

The U-subband for the CSI reporting on a PUCCH may be indicated to the WTRU using a DCI which may trigger the CSI reporting (i.e., the CSI feedback). For example, in a subframe n, an eNode-B may trigger aperiodic CSI reporting which may be indicated by a DCI to the WTRU. The CSI reporting may be transmitted from a WTRU in the subframe n+k, where the DCI may include an indication for a U-subband index that references a U-subband to be used for the CSI reporting on PUCCH. An explicit bit field may be used in the trigger signal (e.g., the DCI) to indicate the U-subband index. The U-subband index may be determined based on a NB-EPDCCH candidate or a search space where a WTRU received the DCI.

For example, NB-EPDCCH candidates may be partitioned into a number of U-subband candidates used for CSI reporting and a U-subband index may be determined based on the NB-EPDCCH candidate where the WTRU received the DCI. An RNTI may be reserved for each U-subband candidate. For example, a first RNTI may be used to indicate a first U-subband index corresponding to a U-subband to be used for CSI reporting and a second RNTI may be used to indicate a second U-subband index corresponding to another U-subband to be used for another CSI reporting by a same or different WTRU.

In another example, two or more CSI-subbands may be associated with a U-subband which may include a plurality of PUCCH resources, and a PUCCH resource index within the U-subband to be used for a CSI reporting may be determined as a function of a CSI-subband index. In this case, one or more of following may apply. Within the plurality of PUCCH resources in a U-subband, a group of PUCCH resources may be determined based on the CSI-subband index for which the CSI reporting is intended, and at least one of following may be used to determine a PUCCH resource within the group of PUCCH resources: a starting (E)CCE index for the (E)PDCCH candidate which may trigger the CSI reporting; an index configured via higher layer signaling; a WTRU-ID (e.g., C-RNTI, IMSI); a CSI reporting type (e.g., a CQI report, a PMI report, and/or an RI report); and a starting subframe of the (E)PDCCH candidate if the (E)PDCCH candidate is transmitted repetitively. A higher layer signaling may indicate a corresponding PUCCH resource for each CSI-subband. For example, if M CSI-subbands are configured, a higher layer signaling may configure M corresponding PUCCH resources for the CSI reporting, where M PUCCH resources may be a different PUCCH sequence in the same time/frequency resources or located in a different time location.

In another example, the CSI feedback on PUCCH may be configured to report periodically. For example, a WTRU may be configured to report a CSI for a certain CSI-subband every K subframes, where a same or a different CSI type may be reported every K subframes. In this case, one or more of following may apply: a single U-subband may be used to report CSI for one or more CSI-subbands and/or two or more U-subbands may be used to report CSI for one or more CSI-subbands.

In an example where a single U-subband may be used to report CSI for one or more CSI-subbands, a PUCCH resource may be configured via higher layer signaling in a WTRU-specific manner. Also, one CSI for a single CSI-subband may be reported at a time. For instance, if M CSI-subbands are configured for CSI feedback, a WTRU may report a first CSI for a first CSI-subband in a first subframe and the WTRU may report a second CSI for a second CSI-subband in a second subframe, where the first and the second subframes may be within a K subframe cycle. Further, one CSI for all CSI-subbands may be reported in each K subframe cycle. In this case, a best CSI-subband index (i.e., DL subband index) and its associated CSI value (e.g., CQI, PMI, and/or RI) may be reported in each K subframe cycle. For example, a WTRU may report a CSI-subband index, which may have a highest CQI value that may result in a highest throughput performance, and its associated CQI value. Thus, a best CSI-subband index among CSI-subband indices (i.e., among CSI subbands) may be determined based on comparing the CSI values for the CSI subbands, a best CSI value (e.g., based on CQI, PMI, and/or RI) among all CSI values may be determined based on the comparison results, and the best CSI-subband index and associated best CSI value may be reported in a CSI feedback report in each K subframe cycle. That is, a determination by the WTRU of which CSI among CSIs is best to report is made each K subframe cycle. A best CSI-subband, a preferred CSI-subband, a selected CSI-subband, a WTRU determined CSI subband, and a reported CSI subband may be used interchangeably herein.

In another example where two or more U-subbands may be used to report CSI for one or more CSI-subbands, an associated U-subband for CSI reporting on PUCCH may be configured or determined for each CSI-subband.

CSI feedback may be reported on a PUSCH for a CSI-subband by a WTRU to a network (e.g., eNobe-B). In an example, a WTRU may be scheduled for a PUSCH transmission based on an associated DCI received in a subframe n and the WTRU may transmit a PUSCH in the subframe n+k where the PUSCH may contain CSI for one or more CSI-subbands. In this case, one or more of following may apply: a DCI associated with a PUSCH may indicate one or more CSI-subband(s) for the CSI feedback and/or two or more CSI-subband groups may be configured via higher layer signaling and one of the CSI-subband groups configured may be indicated by the DCI used for PUSCH scheduling.

In an example where a DCI associated with a PUSCH may indicate one or more CSI-subband(s) for the CSI feedback, a WTRU may report CSI on the scheduled PUSCH resource, where the CSI may be intended for or measured for one or more CSI-subbands indicated by DCI. Also, a single bit in the DCI may be used to indicate the CSI-subband for CSI reporting, where the single bit may indicate CSI reporting in the scheduled PUSCH resource for all CSI-subbands configured, and where the all CSI-subbands configured may be the configured CSI-subbands for the WTRU and may be equal to or smaller than the CSI-subbands available in the cell. Further, the CSI reporting for all configured CSI-subbands may correspond to the aggregated CSI for all CSI-subbands for which a WTRU may be configured to measure CSI. In addition, the CSI reporting for all configured CSI-subbands may correspond to the best N CSI-subband indices and the associated CSI for the best N CSI-subbands determined. Also, the number of bits to indicate the one or more CSI-subband(s) for CSI reporting may be determined as a function of at least one of: a DL system bandwidth and the number of CSI-subbands configured.

In an example where two or more CSI-subband groups may be configured via higher layer signaling and one of the CSI-subband groups configured may be indicated by the DCI to be used for PUSCH scheduling, each CSI-subband group may include non-overlapped one or more CSI-subbands. Alternatively, each CSI-subband group may include fully or partially overlapped one or more CSI-subbands.

In an example, CSI reporting may include collision handling. A WTRU may be scheduled to transmit a first uplink signal in a first U-subband and the WTRU may be scheduled to a second uplink signal in a second U-subband in a same subframe. Thus, the first uplink signal may be a CSI reporting for a first CSI-subband of the configured two or more CSI-subbands and the second uplink signal may be a CSI reporting for a second CSI-subband of the configured two or more CSI-subbands. In this case, one or more of following may apply. One of the uplink signals may be dropped if the first U-subband and the second U-subband are in a different frequency locations (e.g., non-overlapped or partially overlapped, and/or having a different U-subband index) based on a predefined condition. The predefined condition may be a prioritization rule which may be based on CSI-subband index, CSI reporting type (e.g., CQI, PMI, RI), previous latest CSI reporting time, CSI reporting cycle. In an example, the first CSI-subband may be a higher priority than the second CSI-subband. In another example, a CSI type 1 (e.g., wideband CQI) may be a higher priority than a CSI type 2 (e.g., subband CQI). In a further example, a CSI-subband which may have a longer CSI reporting cycle may have a higher priority than a CSI-subband which may have a shorter CSI reporting cycle. A combined CSI for two or more CSI-subbands may be transmitted in a certain U-subband if the first U-subband and the second U-subband are in difference frequency locations.

In another example, the first uplink signal may be a CSI reporting for one or more CSI-subband(s) and the second uplink signal may be another uplink signal which may carry at least one of uplink data, HARQ-ACK, scheduling request (SR), PRACH preamble, and SRS. In this case, one or more of following may apply. One of the uplink signals may be dropped if the first U-subband and the second U-subband are in different frequency locations (e.g., non-overlapped or partially overlapped, different U-subband index) based on a predefined condition. The predefined condition may be a prioritization rule which may be based on the uplink signal type. In an example, the CSI reporting may be dropped if the second uplink signal is one of uplink data, a HARQ-ACK, an SR, or a PRACH preamble. In another example, the CSI reporting may be transmitted if the second uplink signal is SRS. Both first and second uplink signals may be transmitted if the first U-subband and the second U-subband are in a same frequency location (e.g., fully overlapped and/or have the same U-subband index).

In an example, a WTRU may transmit SRSs with multiple subbands. For example, a WTRU may be triggered or configured by a network (e.g., eNobe-B) to transmit an SRS in a certain U-subband in a subframe. The subframe where a WTRU may be triggered or configured to transmit an SRS may be referred to as WTRU-specific SRS subframe. In an example, the certain U-subband may be a single U-subband configured for SRS transmission. As disclosed herein, the U-subband configured for SRS transmission may be referred to as SRS-subband. The certain U-subband may be one of the U-subbands configured for the WTRU.

Within an SRS-subband, a WTRU may transmit an SRS in all PRBs within the SRS-subband. Alternatively, a subset of PRBs may be determined or configured for SRS transmission within the SRS-subband.

In an example, an SRS-subband may be determined for an SRS transmission. Two or more SRS-subbands may be configured and a WTRU may transmit an SRS in one of the SRS-subbands configured or determined for the WTRU in a subframe where the WTRU may be triggered or configured to transmit an SRS. As disclosed herein, the subframe where a WTRU may be triggered or configured to transmit an SRS may be referred to as WTRU-specific SRS subframe.

In an example, an SRS-subband within two or more SRS-subbands in a WTRU-specific SRS subframe may be determined by the WTRU as a function of at least one of following. An SRS-subband may be determined as a function of a D-subband index in which a WTRU may receive a DCI which may trigger an SRS transmission. In an example, two or more D-subbands may be associated with two or more SRS-subbands and each SRS-subband may be linked to a certain D-subband index. Therefore, if a WTRU receives a DCI that may trigger an SRS transmission, the SRS-subband for the SRS transmission may be determined as a function of the D-subband index. A mapping rule between D-subbands and SRS-subbands may be predefined. Also, an SRS-subband may be determined as a function of an index provided by the associated DCI used for triggering SRS transmission. For example, a WTRU may be indicated by a DCI and configured to transmit an SRS and in which SRS-subband. For example, the associated DCI may contain an explicit bit field for an SRS-subband index identifying the SRS-subband to be used to transmit an SRS. Further, an SRS-subband may be determined by the WTRU as a function of an SFN number and/or subframe number of the WTRU-specific SRS subframe. In addition, an SRS-subband may be determined by the WTRU as a function of a WTRU-ID (e.g. C-RNTI or IMSI). Also, an SRS-subband may be determined by the WTRU as a function of the number SRS-subbands configured for the WTRU. Further, an SRS-subband may be determined by the WTRU as a function of an EPDCCH candidate in which a WTRU may receive the associated DCI for SRS triggering. For example, a first subset of EPDCCH candidates may be associated with a first SRS-subband and a second subset of EPDCCH candidates may be associated with a second SRS subband, and so on.

In another example, an SRS-subband within two or more SRS-subbands in a WTRU-specific SRS subframe may be determined by the WTRU based on a predefined subband hopping pattern. The subband hopping pattern may be WTRU-specific and determined based on at least one of following: the number of SRS-subbands configured, an SFN number and/or subframe number, a WTRU-ID (e.g. C-RNTI or IMSI), and/or a higher layer configuration of a starting SRS-subband index.

A WTRU may transmit an SRS in a CE mode of operation. A WTRU in a CE mode of operation may be configured or triggered to transmit an SRS in an SRS-subband.

An SRS may be transmitted repetitively over N_{SRS} SC-FDMA symbols within a WTRU-specific SRS subframe. In an example, consecutive N_{SRS} SC-FDMA symbols may be used for SRS transmission in a subframe. In this case, one or more of following may apply. Start and end SC-FDMA symbols may be determined based on at least one of: a coverage enhancement level, a cell-specific SRS subframe, and a SRS-subband index. The N_{SRS} may be determined based on at least one of the coverage enhancement level, SRS-subband index, and a higher layer parameter related to SRS configuration. The N_{SRS} may be configured via higher layer signaling or indicated from the associated DCI which may be used to trigger SRS transmission. In another example, all SC-FDMA symbols may be used for SRS transmission in a subframe. The last SC-FDMA symbol may be punctured for SRS transmission if the subframe is configured as a cell-specific SRS subframe.

Two or more SRS-subbands may be configured for SRS transmission for coverage enhancement mode of operation and each SRS-subband may be associated with one or more of coverage enhancement levels. The same number of SRS-subbands may be configured with the number of coverage enhancement levels supported in a cell. For example, if three CE levels are supported in a cell, then three SRS-subbands may be configured for CE mode of operation and each SRS-subband may be associated with a CE level. Also, a subset of CE levels may be only supported for SRS transmission.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method for use in a wireless transmit/receive unit (WTRU), the method comprising:
receiving, by the WTRU, configuration information from an base station indicating at least one subband of a plurality of subbands to monitor for an enhanced physical downlink control channel (EPDCCH), wherein each subband of the plurality of subbands is made up of a subset of frequency resources in a system bandwidth;
determining, by the WTRU, the at least one subband to monitor for the EPDCCH based on the received configuration information, wherein each of the at least one determined subband for monitoring the EPDCCH is further determined, by the WTRU, as a channel state information (CSI) downlink subband (CSI-subband) for measuring CSI feedback thereon;
monitoring, by the WTRU, each CSI-subband for the EPDCCH; and
measuring, by the WTRU, the CSI feedback on each CSI-subband.

2. (canceled)

3. (canceled)

4. The method of claim 1, further comprising:
reporting, by the WTRU, the measured CSI feedback for each CSI-subband on at least one uplink channel, wherein each of the at least one uplink channel is associated with a corresponding CSI-subband.

5. The method of claim 4, wherein the measured CSI feedback includes a channel quality indicator (CQI) value for a corresponding CSI-subband.

6. The method of claim 1, further comprising:
determining, by the WTRU, a downlink (DL) subband index for each CSI-subband, and
reporting, by the WTRU, the CSI feedback for at least one determined DL subband index.

7. The method of claim 6, wherein reporting the CSI feedback includes reporting the DL subband index and a channel quality indicator (CQI) value for each of the at least one determined DL subband index being reported.

8. The method of claim 6, wherein reporting the CSI feedback for the at least one determined DL subband index includes reporting the CSI feedback for each of the at least one determined DL subband index one at a time.

9. The method of claim 1, further comprising:
selecting, by the WTRU, a CSI-subband from among CSI-subbands for CSI feedback reporting; and
reporting, by the WTRU, the CSI feedback corresponding to the selected CSI-subband on an uplink channel.

10. The method of claim 9, wherein the selected CSI-subband for CSI feedback reporting is a preferred CSI-subband among the CSI-subbands.

11. The method of claim 10, wherein the preferred CSI-subband has a highest CQI value among the CSI-subbands.

12. The method of claim 9, wherein reporting the CSI feedback for the selected CSI-subband includes reporting a downlink (DL) subband index and a channel quality indicator (CQI) value corresponding to the selected CSI-subband.

13. A wireless transmit/receive unit (WTRU), comprising:
a receiver configured to receive configuration information from an base station indicating at least one subband of a plurality of subbands to monitor for an enhanced physical downlink control channel (EPDCCH), wherein each subband of the plurality of subbands is made up of a subset of frequency resources in a system bandwidth;
at least one processor configured to determine the at least one subband to monitor for the EPDCCH based on the received configuration information, and further determine each of the at least one determined subband for monitoring the EPDCCH as a channel state information (CSI) downlink subband (CSI-subband) for measuring CSI feedback thereon;
the receiver and the at least one processor further configured to monitor each CSI-subband for the EPDCCH; and
the receiver and the at least one processor further configured to measure the CSI feedback on each CSI-subband.

14. (canceled)

15. (canceled)

16. The WTRU of claim 13, further comprising:
a transmitter configured to report the measured CSI feedback for each CSI-subband on at least one uplink channel, wherein each of the at least one uplink channel is associated with a corresponding CSI-subband.

17. The WTRU of claim 16, wherein the measured CSI feedback includes a channel quality indicator (CQI) value for a corresponding CSI-subband.

18. The WTRU of claim 13, wherein the at least one processor is configured to determine a downlink (DL) subband index for each CSI-subband, and
the WTRU further comprises a transmitter configured to report the CSI feedback for at least one determined DL subband index.

19. The WTRU of claim 18, wherein the CSI feedback includes the DL subband index and a channel quality indicator (CQI) value for each of the at least one determined DL subband index being reported.

20. The WTRU of claim 18, wherein the transmitter is configured to report the CSI feedback for each of the at least one determined DL subband index one at a time.

21. The WTRU of claim 13, wherein the at least one processor is configured to select a CSI-subband from among CSI-subbands for CSI feedback reporting, and
the WTRU further comprises a transmitter configured to report the CSI feedback corresponding to the selected CSI-subband on an uplink channel.

22. The WTRU of claim 21, wherein the selected CSI-subband for CSI feedback reporting is a preferred CSI-subband among the CSI-subbands.

23. The WTRU of claim 22, wherein the preferred CSI-subband has a highest CQI value among the CSI-subbands.

24. The WTRU of claim 21, wherein the CSI feedback for the selected CSI-subband includes a downlink (DL) subband index and a channel quality indicator (CQI) value corresponding to the selected CSI-subband.
